(19) United States
(12) Patent Application Publication
(10) Pub. No.: US 2024/0295448 A1
(43) Pub. Date: Sep. 5, 2024

(54) LOAD SENSOR

(71) Applicant: Panasonic Intellectual Property Management Co., Ltd., Osaka (JP)

(72) Inventors: Takashi MATSUMOTO, Osaka (JP); Hiroyuki FURUYA, Osaka (JP); Takafumi HAMANO, Fukuoka (JP); Yuta MORIURA, Osaka (JP); Susumu URAGAMI, Kumamoto (JP); Yodai MATSUMURA, Osaka (JP)

(21) Appl. No.: 18/657,675

(22) Filed: May 7, 2024

Related U.S. Application Data
(63) Continuation of application No. PCT/JP2022/014178, filed on Mar. 24, 2022.

(30) Foreign Application Priority Data
Nov. 9, 2021 (JP) 2021-182796

(51) Int. Cl. G01L 1/14

(52) U.S. Cl. CPC G01L 1/14

(57) ABSTRACT

A load sensor includes: a first base member having a plate shape and having elasticity; a second base member having a plate shape and disposed so as to oppose the first base member; an electrically-conductive elastic body formed on an opposing face of the first base member; an electrically-conductive member having a linear shape and disposed between the first base member and the second base member; a dielectric body formed on an outer periphery of the electrically-conductive member; and an electric conductor formed on the second base member, along the electrically-conductive member.

### CROSS REFERENCE TO RELATED APPLICATION

This application is a continuation of International Application No. PCT/JP2022/014178 filed on Mar. 24, 2022, entitled “LOAD SENSOR”, which claims priority under 35 U.S.C. Section 119 of Japanese Patent Application No. 2021-182796 filed on Nov. 9, 2021, entitled “LOAD SENSOR”. The disclosures of the above applications are incorporated herein by reference.

### BACKGROUND OF THE INVENTION

### Field of the Invention

The present invention relates to a load sensor that detects a load applied from outside, based on change in capacitance.

### Description of Related Art

Load sensors are widely used in the fields of industrial apparatuses, robots, vehicles, and the like. In recent years, in accordance with advancement of control technologies by computers and improvement of design, development of electronic apparatuses that use a variety of free-form surfaces such as those in human-form robots and interior equipment of automobiles is in progress. In association therewith, it is required to mount a high performance load sensor to each free-form surface.

International Publication No. WO2017/022258 discloses a capacitance-type sensor including a dielectric layer and a plurality of electrode units disposed on both sides of the dielectric layer in the front-back direction. In this capacitance-type sensor, each electrode unit includes: an insulating layer having a through hole; an electrode layer disposed on one face in the front-back direction of the insulating layer; and a jumper wiring layer disposed on the other face in the front-back direction of the insulating layer and electrically connected to the electrode layer through the through hole. In a portion where the front-side electrode layer and the back-side electrode layer overlap each other, a plurality of detection parts (element parts) are set. Based on capacitance acquired for each element part, the load applied on the element part is measured.

In the load sensor as in International Publication No. WO2017/022258, when an object including a capacitance component such as a finger is brought close to an element part from outside, the capacitance component of the object causes noise. In this case, the acquired value of the capacitance in the element part cannot be appropriately detected, and the load cannot be accurately detected.

### SUMMARY OF THE INVENTION

A main aspect of the present invention relates to a load sensor. The load sensor according to the present aspect includes: a first base member having a plate shape and having elasticity; a second base member having a plate shape and disposed so as to oppose the first base member; an electrically-conductive elastic body formed on an opposing face of the first base member; an electrically-conductive member having a linear shape and disposed between the first base member and the second base member; a dielectric body formed on an outer periphery of the electrically-conductive member; and an electric conductor formed on the second base member, along the electrically-conductive member.

In the load sensor according to the present aspect, since the electrically-conductive member is sandwiched by the electrically-conductive elastic body and the electric conductor, the electrically-conductive member is electrically shielded from both sides by the electrically-conductive elastic body and the electric conductor. Accordingly, even when a capacitance component comes close to the load sensor, unintentional variation of the value of the capacitance in the element part can be suppressed. Therefore, the load can be accurately detected.

The effects and the significance of the present invention will be further clarified by the description of the embodiments below. However, the embodiments below are merely some examples for implementing the present invention. The present invention is not limited to the description of the embodiments below in any way.

### BRIEF DESCRIPTION OF THE DRAWINGS

FIG. 1A is a perspective view schematically showing a first base member and electrically-conductive parts formed on an opposing face of the first base member, according to Embodiment 1;

FIG. 1B is a perspective view schematically showing a state where electrically-conductive elastic bodies are disposed on the structure in FIG. 1A, according to Embodiment 1;

FIG. 2A is a perspective view schematically showing a second base member, and electric conductors, wires, terminal parts, and a connector that are formed at an opposing face of the second base member, according to Embodiment 1;

FIG. 2B is a perspective view schematically showing a state where an insulation film is set on the structure in FIG. 2A, according to Embodiment 1;

FIG. 3A is a perspective view schematically showing a state where conductor wires are disposed on the structure in FIG. 2B, according to Embodiment 1;

FIG. 3B is a perspective view schematically showing a state where the structure in FIG. 1B is set on the structure in FIG. 3A, according to Embodiment 1;

FIG. 4 schematically shows a cross section of the load sensor along a plane parallel to a Y-Z plane at the center of a hole, according to Embodiment 1;

FIG. 5A and FIG. 5B each schematically show a cross section of an element part along a plane parallel to a X-Z plane at the center position in the Y-axis direction of the element part, according to Embodiment 1;

FIG. 6 is a plan view schematically showing disposition of components of the load sensor when viewed in the Z-axis negative direction, according to Embodiment 1;

FIG. 7 is a schematic diagram showing an example of the potential of each component, according to Embodiment 1;

FIG. 8A is a perspective view schematically showing the second base member, and the electric conductors, the wires, the terminal parts, and the connector that are formed at the lower face of the second base member, according to a modification of Embodiment 1;

FIG. 8B schematically shows a cross section of the load sensor along a plane parallel to a Y-Z plane at the center of a hole, according to a modification of Embodiment 1;

FIG. 9A is a perspective view schematically showing the first base member and the electrically-conductive parts formed on the opposing face of the first base member, according to Embodiment 2;

FIG. 9B is a perspective view schematically showing a state where the electrically-conductive elastic bodies are disposed on the structure in FIG. 9A, according to Embodiment 2;

FIG. 10A is a perspective view schematically showing the second base member, and electric conductors, terminal parts, wires, and the connector that are formed at the opposing face of the second base member, according to Embodiment 2;

FIG. 10B is a perspective view schematically showing a state where the insulation film is set on the structure in FIG. 10A, according to Embodiment 2;

FIG. 11A is a perspective view schematically showing a state where the conductor wires are disposed on the structure in FIG. 10B, according to Embodiment 2;

FIG. 11B is a perspective view schematically showing a state where the structure in FIG. 9B is set on the structure in FIG. 11A, according to Embodiment 2;

FIG. 12 schematically shows a cross section of the load sensor along a plane parallel to an X-Z plane at the center of a hole, according to Embodiment 2;

FIG. 13 is a plan view schematically showing disposition of components of the load sensor when viewed in the Z-axis negative direction, according to Embodiment 2;

FIG. 14 is a schematic diagram showing an example of the potential of each component, according to Embodiment 2;

FIG. 15A is a perspective view schematically showing the second base member, and the electric conductors, the terminal parts, the wires, and the connector that are formed at the lower face of the second base member, according to a modification of Embodiment 2; and

FIG. 15B schematically shows a cross section of the load sensor along a plane parallel to an X-Z plane at the center of a hole, according to the present modification of Embodiment 2.

It is noted that the drawings are solely for description and do not limit the scope of the present invention in any way.

### DETAILED DESCRIPTION

A load sensor according to the present invention is applicable to a load sensor of a management system or an electronic apparatus that performs processing in accordance with an applied load.

Examples of the management system include a stock management system, a driver monitoring system, a coaching management system, a security management system, and a caregiving/nursing management system.

In the stock management system, for example, by a load sensor provided to a stock shelf, the load of a placed stock is detected, and the kinds of commodities and the number of commodities present on the stock shelf are detected. Accordingly, in a store, a factory, a warehouse, and the like, the stock can be efficiently managed, and manpower saving can be realized. In addition, by a load sensor provided in a refrigerator, the load of food in the refrigerator is detected, and the kinds of the food and the quantity and amount of the food in the refrigerator are detected. Accordingly, a menu that uses food in a refrigerator can be automatically proposed.

In the driver monitoring system, by a load sensor provided to a steering device, the distribution of a load (e.g., gripping force, grip position, tread force) applied to the steering device by a driver is monitored, for example. In addition, by a load sensor provided to a vehicle-mounted seat, the distribution of a load (e.g., the position of the center of gravity) applied to the vehicle-mounted seat by the driver in a seated state is monitored. Accordingly, the driving state (sleepiness, mental state, and the like) of the driver can be fed back.

In the coaching management system, for example, by a load sensor provided to the bottom of a shoe, the load distribution at a sole is monitored. Accordingly, correction or guidance to an appropriate walking state or running state can be realized.

In the security management system, for example, by a load sensor provided to a floor, the load distribution is detected when a person passes, and the body weight, stride, passing speed, shoe sole pattern, and the like are detected. Accordingly, the person who has passed can be identified by checking these pieces of detection information against data.

In the caregiving/nursing management system, for example, by load sensors provided to bedclothes and a toilet seat, the distributions of loads applied by a human body to the bedclothes and the toilet seat are monitored. Accordingly, at the positions of the bedclothes and the toilet seat, what action the person is going to take is estimated, whereby tumbling or falling can be prevented.

Examples of the electronic apparatus include a vehicle-mounted apparatus (car navigation system, audio apparatus, etc.), a household electrical appliance (electric pot, IH cooking heater, etc.), a smartphone, an electronic paper, an electronic book reader, a PC keyboard, a game controller, a smartwatch, a wireless earphone, a touch panel, an electronic pen, a penlight, lighting clothes, and a musical instrument. In an electronic apparatus, a load sensor is provided to an input part that receives an input from a user.

The load sensor in the embodiments below is a capacitance-type load sensor that is typically provided in a load sensor of a management system or an electronic apparatus as described above. Such a load sensor may be referred to as a “capacitance-type pressure-sensitive sensor element”, a “capacitive pressure detection sensor element”, a “pressure-sensitive switch element”, or the like. The load sensor in the embodiments below is connected to an external detection circuit, and the load sensor and the detection circuit form a load detection device. The embodiments below are some examples of embodiments of the present invention, and the present invention is not limited to the embodiments below in any way.

Hereinafter, embodiments of the present invention will be described with reference to the drawings. For convenience, X-, Y-, and Z-axes orthogonal to each other are indicated in the drawings. The Z-axis direction is the height direction of a load sensor 1.

### Embodiment 1

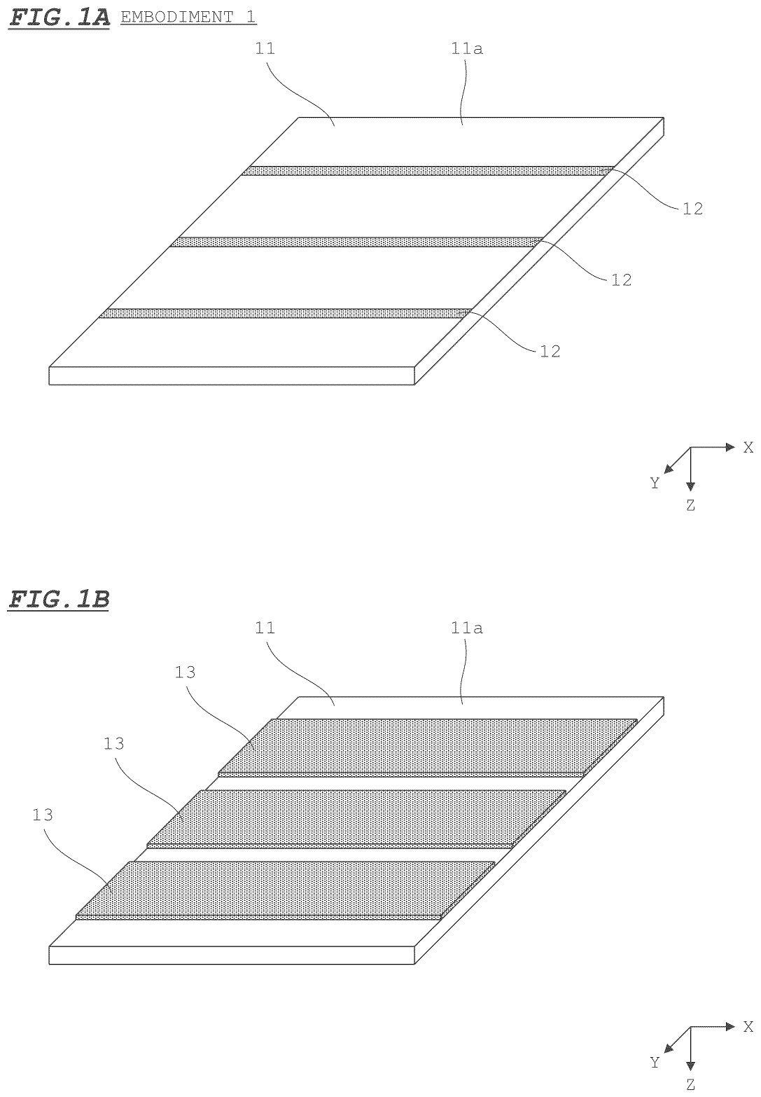

FIG. 1A is a perspective view schematically showing a first base member 11 and electrically-conductive parts 12 formed on an opposing face 11a (the face on the Z-axis negative side) of the first base member 11.

The first base member 11 is an insulative member having elasticity. The first base member 11 is a plate-shaped member having flat planes on the Z-axis positive side and the Z-axis negative side. The planes on the Z-axis positive side and the Z-axis negative side of the first base member 11 are parallel to an X-Y plane. In the present embodiment, the thickness of the first base member 11 is 0.5 mm. The elastic modulus of the first base member 11 is, for example, about 0.01 MPa to 10 MPa, and more specifically about 1 MPa to 5 MPa.

The first base member 11 is formed from a non-electrically-conductive resin material or a non-electrically-conductive rubber material. The resin material used in the first base member 11 is a resin material of at least one type selected from the group consisting of a styrene-based resin, a silicone-based resin (e.g., polydimethylpolysiloxane (PDMS)), an acrylic resin, a rotaxane-based resin, a urethane-based resin, and the like, for example. The rubber material used in the first base member 11 is a rubber material of at least one type selected from the group consisting of silicone rubber, isoprene rubber, butadiene rubber, styrene-butadiene rubber, chloroprene rubber, nitrile rubber, polyisobutylene, ethylene-propylene rubber, chlorosulfonated polyethylene, acrylic rubber, fluororubber, epichlorohydrin rubber, urethane rubber, natural rubber, and the like, for example.

Each electrically-conductive part 12 is formed on the opposing face 11a of the first base member 11. Here, three electrically-conductive parts 12 are disposed on the opposing face 11a of the first base member 11 so as to extend in the X-axis direction. The three electrically-conductive parts 12 are formed so as to be arranged in the Y-axis direction with a predetermined gap therebetween. Each electrically-conductive part 12 is formed from a material having a resistance lower than that of an electrically-conductive elastic body 13 described later. The thickness of the electrically-conductive part 12 is smaller than the thickness of the electrically-conductive elastic body 13 described later. The width in the Y-axis direction of the electrically-conductive part 12 is smaller than the width of the electrically-conductive elastic body 13 described later.

The electrically-conductive part 12 may be omitted. However, when the electrically-conductive part 12 is provided with respect to the electrically-conductive elastic body 13 described later (see FIG. 1B), the electric conductivity of the structure composed of the electrically-conductive elastic body 13 and the electrically-conductive part 12 can be made higher than the electric conductivity of the electrically-conductive elastic body 13 only.

FIG. 1B is a perspective view schematically showing a state where the electrically-conductive elastic bodies 13 are disposed on the structure in FIG. 1A.

Each electrically-conductive elastic body 13 is formed on the opposing face 11a of the first base member 11 so as to cover a corresponding electrically-conductive part 12. The electrically-conductive elastic body 13 is formed on the opposing face 11a such that the electrically-conductive part 12 is positioned at a substantially middle position of the electrically-conductive elastic body 13 in the Y-axis direction. Here, three electrically-conductive elastic bodies 13 are disposed on the opposing face 11a of the first base member 11 so as to extend in the X-axis direction. The three electrically-conductive elastic bodies 13 are formed so as to be arranged in the Y-axis direction with a predetermined gap therebetween.

Each electrically-conductive elastic body 13 is a member that is electrically conductive and that has elasticity.

The electrically-conductive part 12 and the electrically-conductive elastic body 13 formed so as to cover the electrically-conductive part 12 are in a state of being electrically connected with each other. The electrically-conductive part 12 and the electrically-conductive elastic body 13 are each formed from a resin material and an electrically-conductive filler dispersed therein, or from a rubber material and an electrically-conductive filler dispersed therein.

Similar to the resin material used in the first base member 11 described above, the resin material used in the electrically-conductive part 12 and the electrically-conductive elastic body 13 is a resin material of at least one type selected from the group consisting of a styrene-based resin, a silicone-based resin (e.g., polydimethylpolysiloxane (PDMS)), an acrylic resin, a rotaxane-based resin, a urethane-based resin, and the like, for example. Similar to the rubber material used in the first base member 11 described above, the rubber material used in the electrically-conductive part 12 and the electrically-conductive elastic body 13 is a rubber material of at least one type selected from the group consisting of silicone rubber, isoprene rubber, butadiene rubber, styrene-butadiene rubber, chloroprene rubber, nitrile rubber, polyisobutylene, ethylene-propylene rubber, chlorosulfonated polyethylene, acrylic rubber, fluororubber, epichlorohydrin rubber, urethane rubber, natural rubber, and the like, for example.

The electrically-conductive filler forming the electrically-conductive part 12 and the electrically-conductive elastic body 13 is a material of at least one type selected from the group consisting of: metal materials such as Au (gold), Ag (silver), Cu (copper), C (carbon), ZnO (zinc oxide), In₂O ₃ (indium oxide (III)), and SnO₂ (tin oxide (IV)); electrically-conductive macromolecule materials such as PEDOT: PSS (i.e., a complex composed of poly(3,4-ethylenedioxythiophene) (PEDOT) and polystyrene sulfonate (PSS)); and electrically-conductive fibers such as a metal-coated organic matter fiber and a metal wire (fiber state), for example.

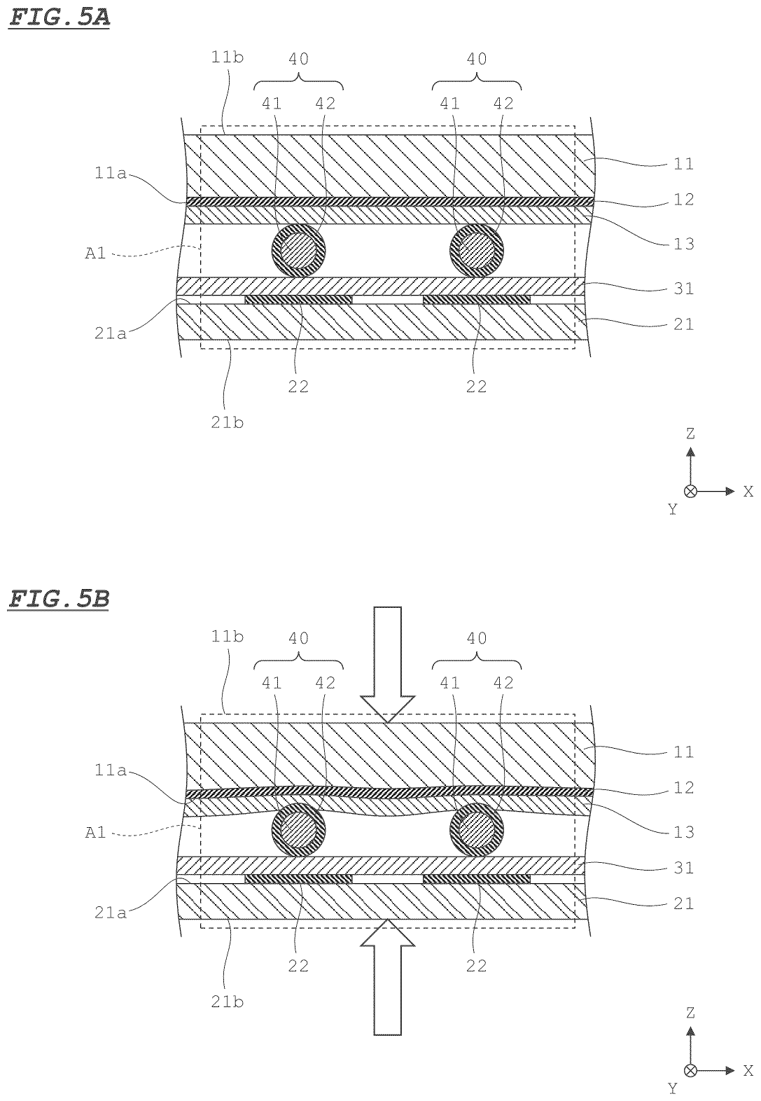

In Embodiment 1, the electrically-conductive filler forming the electrically-conductive part 12 is Ag (silver), and the electrically-conductive filler forming the electrically-conductive elastic body 13 is C (carbon). Accordingly, the electrically-conductive part 12 has a higher electric conductivity than the electrically-conductive elastic body 13. In general, a material having a high electric conductivity is expensive. However, with this configuration, the amount of the electrically-conductive part 12 having a high electric conductivity can be reduced, and thus, the cost of the electrically-conductive part 12 can be kept low. In addition, in general, when an elastic body includes a material having a high electric conductivity, the elastic modulus becomes high (the elastic body itself becomes hard). However, with this configuration, since the width in the Y-axis direction of the electrically-conductive part 12 at the position of an electrically-conductive member 41 described later (see FIGS. 5A, 5B) is small, the elastic modulus of the structure composed of the electrically-conductive part 12 and the electrically-conductive elastic body 13 can be kept low. Therefore, the capacitance is allowed to smoothly change in accordance with the load.

In Embodiment 1, the elastic modulus of the electrically-conductive elastic body 13 is set to be at the same level as the elastic modulus of the first base member 11. Since the electrically-conductive part 12 includes Ag (silver) as the electrically-conductive filler, the elastic modulus of the electrically-conductive part 12 is slightly higher than the elastic modulus of the electrically-conductive elastic body 13, and is several MPa or more or several tens of MPa or more, for example.

The electrically-conductive part 12 and the electrically-conductive elastic body 13 are formed on the opposing face 11a of the first base member 11 by a printing method such as screen printing, gravure printing, flexographic printing, offset printing, or gravure offset printing. After the electrically-conductive part 12 is formed as shown in FIG. 1A, the electrically-conductive elastic body 13 is formed so as to overlap the electrically-conductive part 12 as shown in FIG. 1B. With these printing methods, the electrically-conductive part 12 and the electrically-conductive elastic body 13 can be formed so as to have a thickness of about 0.001 mm to 0.5 mm on the opposing face 11a of the first base member 11. However, the method for forming the electrically-conductive part 12 and the electrically-conductive elastic body 13 is not limited to the above printing methods.

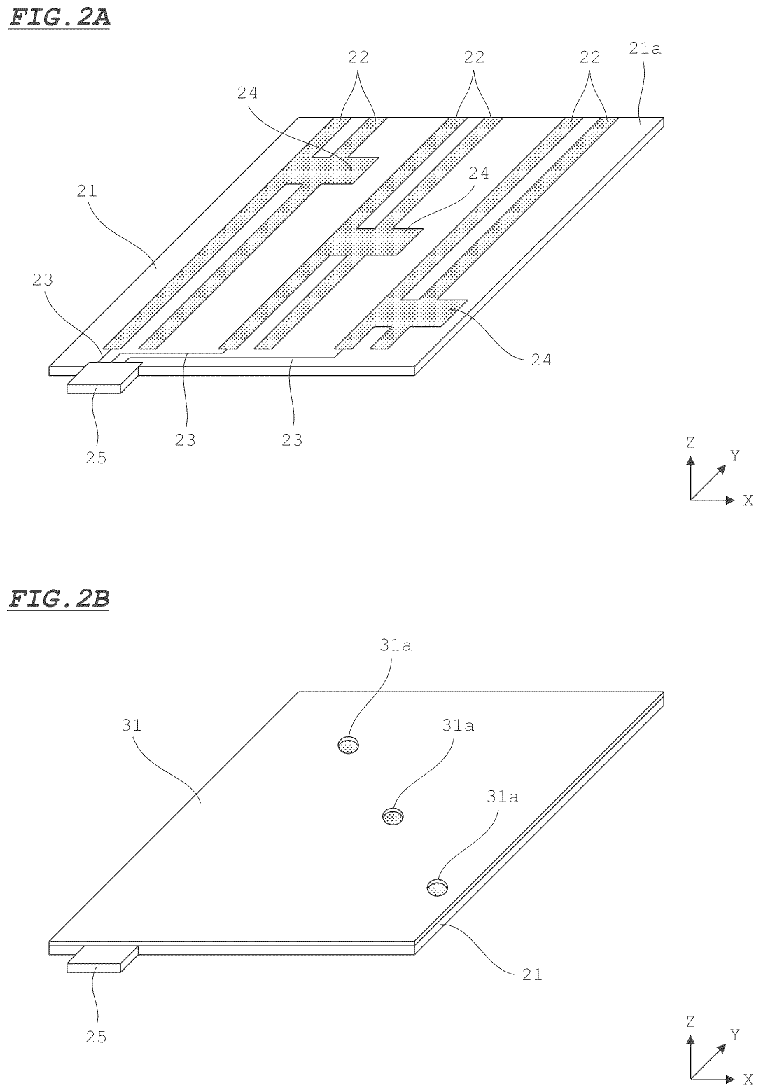

FIG. 2A is a perspective view schematically showing a second base member 21, and electric conductors 22, wires 23, terminal parts 24, and a connector 25 that are formed at an opposing face 21a (the face on the Z-axis positive side) of the second base member 21.

The second base member 21 is an insulative member. The second base member 21 is a plate-shaped member having flat planes on the Z-axis positive side and the Z-axis negative side. The planes on the Z-axis positive side and the Z-axis negative side of the second base member 21 are parallel to an X-Y plane. As described later, the second base member 21 is disposed so as to oppose the first base member 11. In Embodiment 1, the thickness of the second base member 21 is 0.1 mm. The rigidity of the second base member 21 is high, and the elastic modulus of the second base member 21 is 30 MPa or more.

The second base member 21 is formed from a non-electrically-conductive resin material. The resin material used in the second base member 21 is a resin material of at least one type selected from the group consisting of polyurethane, polyethylene terephthalate, polyethylene, polycarbonate, polyimide, and the like, for example.

The electric conductors 22, the wires 23, and the terminal parts 24 are formed on the opposing face 21a of the second base member 21. Here, six electric conductors 22 extending in the Y-axis direction are arranged with a predetermined gap therebetween in the X-axis direction, and three sets (each being a pair of electric conductors 22) each composed of adjacent two electric conductors 22 are arranged in the X-axis direction. A wire 23 extends from an end portion on the Y-axis negative side of the electric conductor 22 on the X-axis negative side in each pair of electric conductors 22, toward the side on the Y-axis negative side of the second base member 21. Adjacent pairs of electric conductors 22 are connected together at a predetermined position in the Y-axis direction, and from this connection position, a terminal part 24 protrudes in the X-axis positive direction. For one pair of electric conductors 22, one terminal part 24 is disposed. The three terminal parts 24 are respectively disposed at positions opposing the three electrically-conductive elastic bodies 13 shown in FIG. 1B.

A pair of electric conductors 22, a wire 23 connected to the pair of electric conductors 22, and a terminal part 24 protruding from the pair of electric conductors 22 are integrally formed and are in a state of being electrically connected to each other. The electric conductor 22, the wire 23, and the terminal part 24 are formed from the same material with each other, and similar to the electrically-conductive part 12 described above, are formed from a resin material and an electrically-conductive filler dispersed therein, or from a rubber material and an electrically-conductive filler dispersed therein. In Embodiment 1, the electrically-conductive filler forming the electric conductor 22, the wire 23, and the terminal part 24 is Ag (silver). In Embodiment 1, the elastic modulus of the electric conductor 22, the wire 23, and the terminal part 24 is substantially the same as the elastic modulus of the electrically-conductive part 12 shown in FIG. 1A.

The electric conductor 22, the wire 23, and the terminal part 24 are formed on the opposing face 21a of the second base member 21 by a printing method such as screen printing, gravure printing, flexographic printing, offset printing, or gravure offset printing. With these printing methods, each component can be formed so as to have a thickness of about 0.001 mm to 0.5 mm on the opposing face 21a of the second base member 21. However, the method for forming each component is not limited to the above printing methods.

After the electric conductors 22, the wires 23, and the terminal parts 24 have been formed on the second base member 21, the connector 25 is set at the side on the Y-axis negative side of the second base member 21 so as to be connected to the three wires 23. The connector 25 is a connector for connecting the wires 23 to an external circuit.

FIG. 2B is a perspective view schematically showing a state where an insulation film 31 is set on the structure in FIG. 2A.

The insulation film 31 is an insulative member. The insulation film 31 is a sheet-shaped member and is parallel to an X-Y plane. In the present embodiment, the thickness of the insulation film 31 is 0.03 mm. The elastic modulus of the insulation film 31 is 30 MPa or more.

The insulation film 31 is formed from a non-electrically-conductive resin material. The resin material used in the insulation film 31 is a resin material of at least one type selected from the group consisting of polyurethane, polyethylene terephthalate, polyethylene, polycarbonate, polyimide, and the like, for example.

In the insulation film 31, at a position corresponding to an end portion (an opposing part 24a described later) in the X-axis positive direction of each terminal part 24 in FIG. 2A, a hole 31a penetrating the insulation film 31 in the up-down direction is formed. The hole 31a is used for joining the electrically-conductive elastic body 13 and the terminal part 24 as described later.

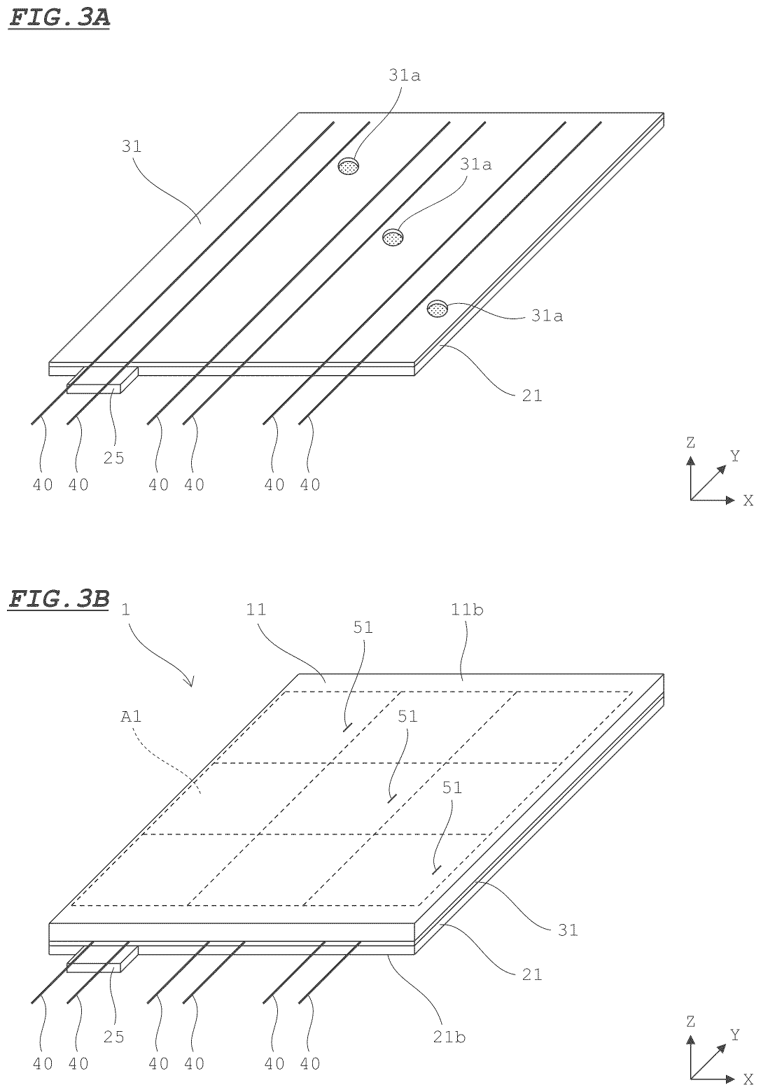

FIG. 3A is a perspective view schematically showing a state where conductor wires 40 are disposed on the structure in FIG. 2B.

The conductor wires 40 are disposed so as to be superposed on the upper face of the insulation film 31. Here, six conductor wires 40 extending in the Y-axis direction are arranged with a predetermined gap therebetween in the X-axis direction, and three sets (each being a pair of conductor wires 40) each composed of adjacent two conductor wires 40 are arranged in the X-axis direction. In a plan view, the six conductor wires 40 are disposed at the same positions as the six electric conductors 22 shown in FIG. 2A. Two conductor wires 40 forming a pair are connected to each other in an external detection circuit in a subsequent stage. The conductor wires 40 forming a pair may be connected at an end portion on the Y-axis positive side.

Each conductor wire 40 is composed of: an electrically-conductive member 41 having a linear shape; and a dielectric body 42 formed on the surface of the electrically-conductive member 41. The configuration of the conductor wire 40 will be described later with reference to FIGS. 5A, 5B.

After the conductor wires 40 have been disposed as shown in FIG. 3A, each conductor wire 40 is set to the second base member 21 by a thread so as to be able to move in the direction (the Y-axis direction) in which the conductor wire 40 extends. The thread for setting the conductor wire 40 need not necessarily be set to the second base member 21, and may be set to the first base member 11.

FIG. 3B is a perspective view schematically showing a state where the structure in FIG. 1B is set on the structure in FIG. 3A.

The structure in FIG. 1B is superposed upside down, from above (the Z-axis positive side) the structure in FIG. 3A. Accordingly, the conductor wires 40 come into contact with the electrically-conductive elastic bodies 13 disposed on the first base member 11.

Then, threads 51 are sewn to an upper face 11b of the first base member 11 and a lower face 21b of the second base member 21 through the holes 31a. At this time, an electrically-conductive elastic body 13 is positioned above each hole 31a, and a terminal part 24 is positioned below the hole 31a. Therefore, as a result of the threads 51 being sewn to the upper face 11b and the lower face 21b, the electrically-conductive elastic bodies 13 and the terminal parts 24 of the electric conductors 22 are pressed against each other to be electrically connected. Each thread 51 is implemented by a chemical fiber, a natural fiber, a mixed fiber of the chemical fiber and the natural fiber, or the like. The thread 51 of Embodiment 1 is formed from a non-electrically-conductive material.

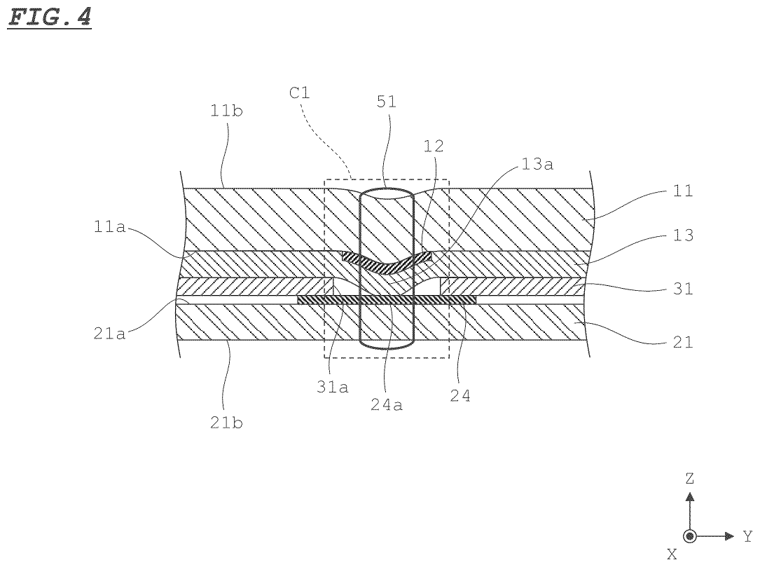

FIG. 4 schematically shows a cross section of the load sensor 1 along a plane parallel to a Y-Z plane at the center of a hole 31a.

The thread 51, the first base member 11, the electrically-conductive part 12, the electrically-conductive elastic body 13, the hole 31a, the terminal part 24, and the second base member 21 that are within the range of the broken line shown in FIG. 4 form a connection structure C1 for electrically connecting the electrically-conductive elastic body 13 and the electric conductor 22 to each other.

An opposing part 13a of the electrically-conductive elastic body 13 is positioned above the hole 31a, and the opposing part 24a of the terminal part 24 is positioned below the hole 31a. That is, the opposing part 13a and the opposing part 24a oppose each other in the up-down direction (the Z-axis direction) through the hole 31a. As described above, when the thread 51 is sewn to the first base member 11 and the second base member 21 through the hole 31a, the opposing part 13a and the opposing part 24a are pressed against each other to be electrically connected.

With reference back to FIG. 3B, then, the outer periphery of the first base member 11 is connected to the second base member 21 by a thread, whereby the first base member 11 is fixed to the second base member 21. In this manner, the load sensor 1 is completed as shown in FIG. 3B.

The load sensor 1 is used in a state where the first base member 11 is oriented to the upper side (the Z-axis positive side) and the second base member 21 is oriented to the lower side (the Z-axis negative side). In this case, the upper face 11b of the first base member 11 serves as the face to which a load is applied.

Here, in the load sensor 1, in a plan view, a plurality of element parts A1 arranged in a matrix shape are formed. In the load sensor 1, a total of nine element parts A1 arranged in the X-axis direction and the Y-axis direction are formed. One element part A1 corresponds to a region including the intersection between an electrically-conductive elastic body 13 and a pair of conductor wires 40 disposed below the electrically-conductive elastic body 13. That is, one element part A1 includes the first base member 11, the electrically-conductive part 12, the electrically-conductive elastic body 13, the conductor wires 40, and the second base member 21 that are near the intersection. When the lower face (the lower face 21b of the second base member 21) of the load sensor 1 is set on a predetermined installation surface, and a load is applied to the upper face (the upper face 11b of the first base member 11) of the load sensor 1 forming the element part A1, the capacitance between the electrically-conductive elastic body 13 and the electrically-conductive member in each conductor wire 40 changes and the load is detected based on the capacitance.

FIGS. 5A, 5B each schematically show a cross section of an element part A1 along a plane parallel to a X-Z plane at the center position in the Y-axis direction of the element part A1.

FIG. 5A shows a state where no load is applied, and FIG. 5B shows a state where loads are applied. In FIGS. 5A, 5B, the lower face 21b on the Z-axis negative side of the second base member 21 is set on the installation surface.

As shown in FIGS. 5A, 5B, each conductor wire 40 is composed of the electrically-conductive member 41 and the dielectric body 42 formed on the electrically-conductive member 41. The dielectric body 42 is formed on the outer periphery of the electrically-conductive member 41 and covers the surface of the electrically-conductive member 41.

The electrically-conductive member 41 is a member having a linear shape. The electrically-conductive member 41 is formed from an electrically-conductive metal material, for example. Other than this, the electrically-conductive member 41 may be composed of a core wire made of glass, and an electrically-conductive layer formed on the surface of the core wire, or may be composed of a core wire made of resin, and an electrically-conductive layer formed on the surface of the core wire, for example. For example, as the electrically-conductive member 41, a valve action metal such as aluminum (Al), titanium (Ti), tantalum (Ta), niobium (Nb), zirconium (Zr), or hafnium (Hf); tungsten (W); molybdenum (Mo); copper (Cu); nickel (Ni); silver (Ag); gold (Au); or the like is used.

The dielectric body 42 has an insulation property, and is formed from a resin material, a ceramic material, a metal oxide material, or the like, for example. The dielectric body 42 may be a resin material of at least one type selected from the group consisting of a polypropylene resin, a polyester resin (e.g., polyethylene terephthalate resin), a polyimide resin, a polyphenylene sulfide resin, a polyvinyl formal resin, a polyurethane resin, a polyamide imide resin, a polyamide resin, and the like. Alternatively, the dielectric body 42 may be a metal oxide material of at least one type selected from the group consisting of Al₂O₃, Ta₂O₅, and the like.

As shown in FIG. 5A, when no load is applied to the element part A1, the force applied between the electrically-conductive elastic body 13 and the conductor wire 40, and the force applied between the insulation film 31 and the conductor wire 40 is substantially zero. From this state, when a load is applied in the downward direction to the upper face 11b of the element part A1 as shown in FIG. 5B, the electrically-conductive elastic body 13, the electrically-conductive part 12, and the first base member 11 are deformed by the conductor wire 40.

When loads are applied as shown in FIG. 5B, the conductor wire 40 is brought close to the electrically-conductive elastic body 13 so as to be wrapped by the electrically-conductive elastic body 13, and the contact area between the conductor wire 40 and the electrically-conductive elastic body 13 increases. Accordingly, the capacitance between the electrically-conductive member 41 and the electrically-conductive elastic body 13 changes. Then, the potential reflecting the change in the capacitance in the element part A1 is measured by the external circuit, whereby the load applied to the element part A1 is calculated.

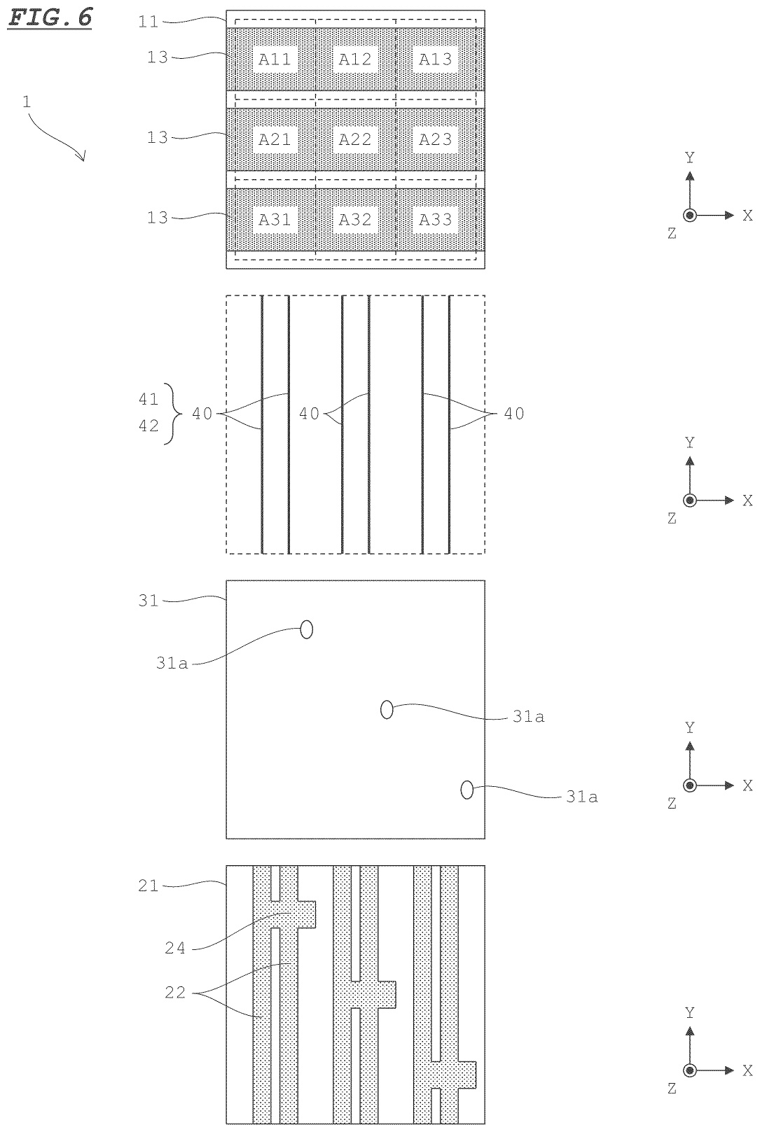

FIG. 6 is a plan view schematically showing disposition of components of the load sensor 1 when viewed in the Z-axis negative direction.

In FIG. 6, for convenience, a layer composed of the first base member 11 and the electrically-conductive elastic bodies 13, a layer composed of the conductor wires 40, a layer composed of the insulation film 31, and a layer composed of the second base member 21, the electric conductors 22, and the terminal parts 24 are arranged to be shown. The electrically-conductive elastic bodies 13 are shown in a state of being seen through the first base member 11.

In the measurement region of the load sensor 1, as described above, nine element parts A1 arranged in a matrix shape are formed. The nine element parts A1 correspond to nine positions at each of which an electrically-conductive elastic body 13 and a pair of conductor wires 40 cross each other. Hereinafter, these nine element parts A1 will be referred to as A11, A12, A13, A21, A22, A23, A31, A32, A33.

The electrically-conductive elastic body 13 corresponding to the element parts A11 to A13 is connected to the terminal part 24 connected to the pair of electric conductors 22 on the X-axis negative side, through the hole 31a on the X-axis negative side. Similarly, the electrically-conductive elastic body 13 corresponding to the element parts A21 to A23 is connected to the terminal part 24 connected to the pair of electric conductors 22 at the center, through the hole 31a at the center. The electrically-conductive elastic body 13 corresponding to the element parts A31 to A33 is connected to the terminal part 24 connected to the pair of electric conductors 22 on the X-axis positive side, through the hole 31a on the X-axis positive side. The external circuit sequentially changes the element part to serve as a load detection target, at a predetermined time interval.

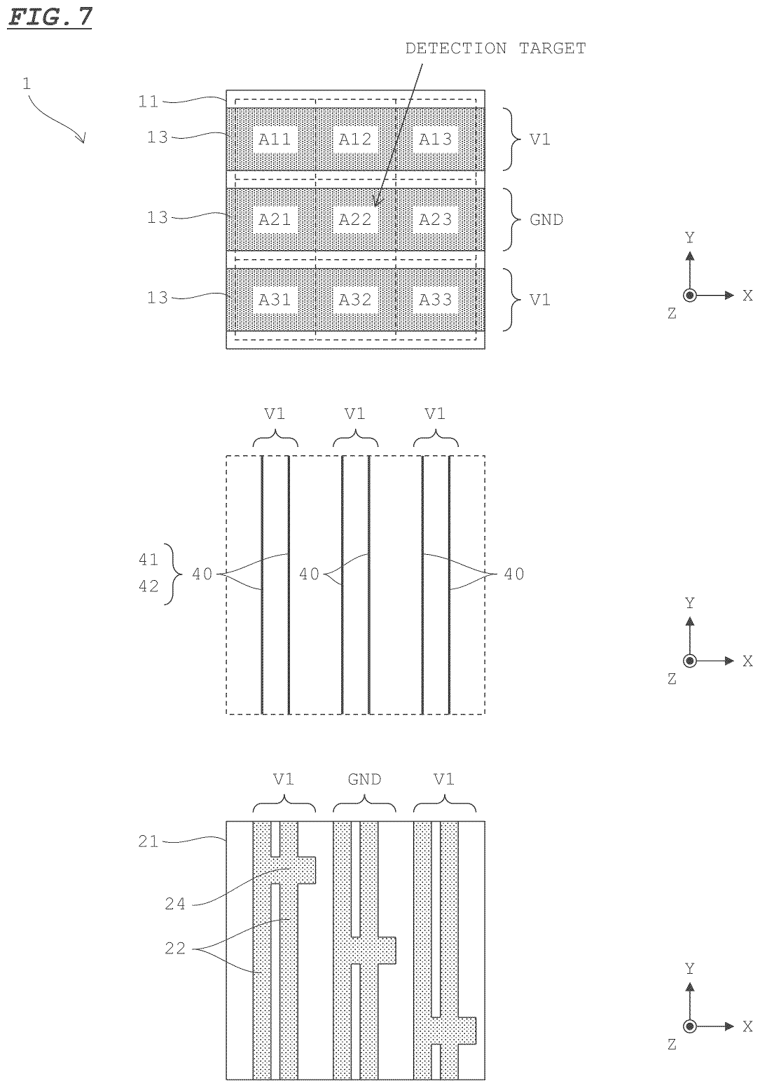

FIG. 7 is a schematic diagram showing the potential of each component when the element part A22 is the load detection target. Hereinafter, as an example, a procedure of detecting, when a load is applied to the element part A22 from the upper face 11b (see FIG. 3B) of the first base member 11, the load applied to the element part A22 will be described.

The external circuit connects the electrically-conductive elastic body 13 at the center corresponding to the element part A22 to the ground, and applies a constant voltage (Vcc) to the electrically-conductive members 41 in the pair of conductor wires 40 corresponding to the element part A22. Specifically, the external circuit connects the pair of electric conductors 22 at the center to the ground, thereby connecting the electrically-conductive elastic body 13 at the center to the ground. The external circuit applies the constant voltage (Vcc) to the electrically-conductive members 41 in the pair of conductor wires 40 at the center. Accordingly, the potential of the electrically-conductive elastic body 13 at the center becomes the ground potential (GND), and a potential V1 of the electrically-conductive members 41 in the pair of conductor wires 40 at the center gradually increases according to the time constant based on the capacitance in the element part A22.

Further, the external circuit sets the potentials of the electrically-conductive elastic bodies 13 and the electrically-conductive members 41 other than the element part A22 serving as the detection target, to the potential V1 which is the same as that of the pair of electrically-conductive members 41 at the center corresponding to the element part A22. Specifically, the external circuit sets the potential V1 to the pairs of electric conductors 22 on the X-axis positive side and the X-axis negative side, thereby setting the potential V1 to the electrically-conductive elastic bodies 13 on the Y-axis positive side and the Y-axis negative side. In addition, the external circuit sets the potential V1 to the electrically-conductive members 41 in the pairs of conductor wires 40 on the X-axis positive side and the X-axis negative side.

At a timing after elapse of a predetermined time from the application of the constant voltage (Vcc), the external circuit measures the potential V1 of the pair of electrically-conductive members 41 (the electrically-conductive members 41 corresponding to the element part A22 serving as the detection target) at the center. The external circuit calculates the capacitance in the element part A22, based on the measured potential V1. Then, the external circuit acquires the load applied to the element part A22, based on the calculated capacitance.

Here, in a case where (Comparative Example) the layer composed of the electric conductors 22 as above is not disposed on the Z-axis negative side (the lower side) of the layer composed of the conductor wires 40, if a capacitance component comes close from the lower side of the conductor wires 40, the time constant changes from the original value under influence of the capacitance component from outside, whereby an error occurs in change in the potential V1. Accordingly, the capacitance detection accuracy decreases. In contrast to this, in Embodiment 1, the layer composed of the electric conductors 22 as above is disposed on the Z-axis negative side (the lower side) of the layer composed of the conductor wires 40, and the potential V1 or the ground potential (GND) is set to the electric conductors 22. Accordingly, the lower side of the conductor wires 40 is electrically shielded by the electric conductors 22. Therefore, even when a capacitance component comes close from the lower side of the conductor wires 40, occurrence of an error in change in the potential V1 is suppressed. Accordingly, the capacitance detection accuracy is maintained at a high level.

In Embodiment 1, the layer composed of the electrically-conductive elastic bodies 13 as above is disposed on the Z-axis positive side (the upper side) of the layer composed of the conductor wires 40, and the potential V1 or the ground potential (GND) is set to the electrically-conductive elastic bodies 13. Accordingly, the upper side of the conductor wires 40 is electrically shielded by the electrically-conductive elastic bodies 13. Therefore, even when a capacitance component comes close from the upper side of the electrically-conductive elastic bodies 13, occurrence of an error in change in the potential V1 is suppressed. Accordingly, the capacitance detection accuracy is maintained at a high level.

In Embodiment 1, the electric conductor 22 is continuously disposed in the Y-axis direction along the conductor wire 40, directly below (the z-axis negative direction) the electrically-conductive member 41. Further, the width in the X-axis direction of one electric conductor 22 is larger than the width in the X-axis direction of one conductor wire 40. For example, the width in the X-axis direction of one conductor wire 40 is 0.06 mm to 1 mm, whereas the width in the X-axis direction of one electric conductor 22 is 1 mm to 2 mm. Specifically, the width in the X-axis direction of one conductor wire 40 is about 0.6 mm, whereas the width in the X-axis direction of one electric conductor 22 is about 1.2 mm. Thus, since the electric conductor 22 is disposed so as to cover the conductor wire 40 in the width direction, the conductor wire 40 is assuredly shielded by the electric conductor 22 from an external capacitance component positioned on the lower side.

### Effects of Embodiment 1

According to Embodiment 1, the following effects are exhibited.

The electrically-conductive elastic body 13 is formed on the opposing face 11a of the first base member 11, the electrically-conductive member 41 having a linear shape is disposed between the first base member 11 and the second base member 21, and the electric conductor 22 is formed on the second base member 21 along the electrically-conductive member 41. With this configuration, since the electrically-conductive member 41 is sandwiched by the electrically-conductive elastic body 13 and the electric conductor 22, the electrically-conductive member 41 is electrically shielded from both sides by the electrically-conductive elastic body 13 and the electric conductor 22. Accordingly, even when a capacitance component comes close to the load sensor 1, unintentional variation of the value of the capacitance in the element part A1 can be suppressed. Therefore, the load can be accurately detected.

As shown in FIG. 2A, each electric conductor 22 is formed on the opposing face 21a of the second base member 21. With this configuration, the electric conductor 22 can be disposed so as to be close to the electrically-conductive elastic body 13. Accordingly, a capacitance component coming close from the second base member 21 side can be assuredly shielded with respect to the electric conductor 22.

As shown in FIG. 3A, the insulation film 31 is disposed between the second base member 21 and the electrically-conductive member 41. Accordingly, the electrically-conductive member 41 and the electric conductor 22 are assuredly insulated from each other. Therefore, the load applied to the element part A1 can be appropriately and stably detected.

As shown in FIG. 4, the load sensor 1 includes the connection structure C1 in which the electrically-conductive elastic body 13 and the electric conductor 22 are electrically connected to each other. Accordingly, as compared with a case where voltage control is separately performed for the electrically-conductive elastic body 13 and the electric conductor 22, voltage control for both of the electrically-conductive elastic body 13 and the electric conductor 22 can be performed by using either one (in Embodiment 1, the electric conductor 22) of the electrically-conductive elastic body 13 and the electric conductor 22. Therefore, the configuration of the load sensor 1 can be simplified.

The elastic modulus of the second base member 21 is higher than the elastic modulus of the first base member 11. In Embodiment 1, the elastic modulus of the second base member 21 is 30 MPa or more.

Here, in order to allow a load to be appropriately applied to the element part A1, the elastic modulus of the first base member 11 is set to be low, and the thickness of the first base member 11 is set to be small. As described above, the elastic modulus of the first base member 11 is set to about 0.01 MPa to 10 MPa, for example, and the thickness of the first base member 11 is set to about 0.5 mm, for example. When the first base member 11 is soft and thin like this, it is difficult to draw, directly from the first base member 11, a wire for applying a voltage to the electrically-conductive elastic body 13.

In contrast to this, in the present embodiment, as described above, the elastic modulus of the second base member 21 is set to 30 MPa or more, which is higher than that of the first base member 11. Therefore, a wire can be easily drawn from the hard second base member 21. Further, since the electrically-conductive elastic body 13 and the electric conductor 22 are electrically connected to each other due to the connection structure C1, a predetermined potential can be set to each electrically-conductive elastic body 13 via a corresponding wire 23 and the connector 25 (see FIG. 2A) provided to the second base member 21.

In a case where a wire for applying a voltage to the electrically-conductive elastic body 13 is separately drawn directly from the first base member 11, it is necessary that, for example: the electrically-conductive part 12 is extended to be drawn in the X-axis positive direction from the electrically-conductive elastic body 13; and in the region where the electrically-conductive part 12 has been drawn, the electrically-conductive part 12 is connected to a wire continuous to the external circuit. In this case, a space for connecting the electrically-conductive part 12 and the wire continuous to the external circuit is necessary, which poses a problem that the installation area of the load sensor 1 becomes large. In contrast to this, in the present embodiment, since the electric conductor 22 and the electrically-conductive elastic body 13 are connected to each other in the measurement region and a potential is set to the electrically-conductive elastic body 13 via the electric conductor 22, the installation area of the load sensor 1 can be made small.

As shown in FIG. 4, in the connection structure C1, the opposing parts 13a, 24a disposed, so as to oppose each other, at the respective opposing faces 11a, 21a of the first base member 11 and the second base member 21 are pressed against each other, whereby the electrically-conductive elastic body 13 and the electric conductor 22 are electrically connected to each other. Accordingly, the electrically-conductive elastic body 13 and the electric conductor 22 can be easily connected. In addition, since the two opposing parts 13a, 24a are in surface contact with each other, the electric resistance at the interface between the electrically-conductive elastic body 13 and the electric conductor 22 can be kept low. Therefore, the capacitance in the element part A1 can be appropriately detected.

As shown in FIG. 4, in the connection structure C1, the first base member 11 and the second base member 21 are sewn to each other at the position of the two opposing parts 13a, 24a, thereby causing these opposing parts 13a, 24a to be pressed against each other. Accordingly, the two opposing parts 13a, 24a can be easily pressed against each other. Since the thread is strong and stretchable, the two opposing parts 13a, 24a can be stably pressed against each other with a sufficient strength.

As shown in FIG. 6, a plurality of the electrically-conductive elastic bodies 13 extending in one direction (the X-axis direction) are formed on the first base member 11 so as to be arranged in the width direction (the Y-axis direction), a plurality of the electrically-conductive members 41 are disposed so as to be arranged in such a manner as to cross the plurality of the electrically-conductive elastic bodies 13, and the electric conductor 22 is continuously disposed along each of the electrically-conductive members 41. With this, the electric conductor 22 is disposed without a gap along the electrically-conductive member 41, and thus, noise can be assuredly suppressed from being superposed on the electrically-conductive member 41 from the second base member 21 side. As compared with a case where one electric conductor having a size similar to that of the region (measurement region) of all of the element parts A1 is disposed, the electric conductor 22 is disposed only at the position corresponding to the electrically-conductive member 41. Thus, the potential of the electric conductor 22 can be stabilized, and the cost of the load sensor 1 can be suppressed.

### Modification of Embodiment 1

In Embodiment 1 above, each electric conductor 22 is disposed on the upper face (the opposing face 11a) of the second base member 21. However, the electric conductor 22 may be disposed on the lower face 21b of the second base member 21.

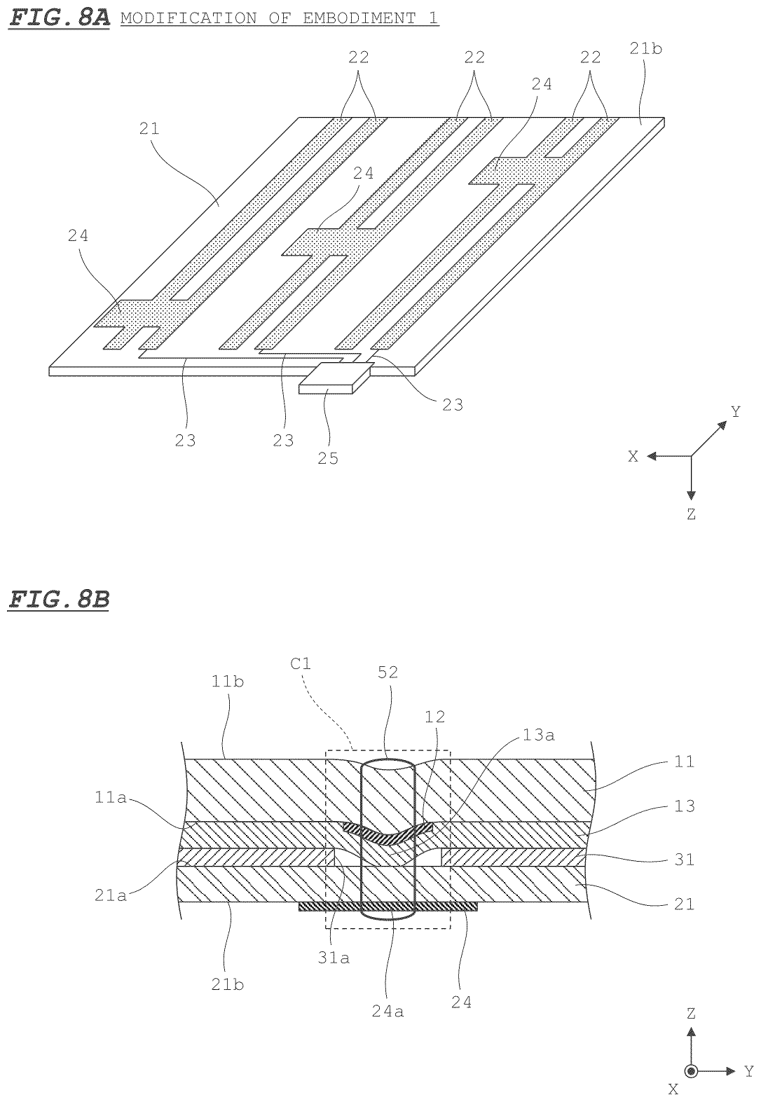

FIG. 8A is a perspective view schematically showing the second base member 21, and the electric conductors 22, the wires 23, the terminal parts 24, and the connector 25 that are formed at the lower face 21b (the face on the Z-axis negative side) of the second base member 21, according to the present modification.

The disposition of the electric conductors 22, the wires 23, the terminal parts 24, and the connector 25 of the present modification when viewed in the Z-axis negative direction is the same as that of Embodiment 1 above. The present modification is configured in the same manner as Embodiment 1 above except that each component set to the second base member 21 is disposed at the lower face 21b of the second base member 21. The insulation film 31 and the conductor wires 40 in FIG. 3A are disposed from above (the Z-axis positive side) the structure in FIG. 8A inverted upside down, the structure in FIG. 1B is superposed upside down thereon, and threads 52 are sewn. In this manner, the load sensor 1 is completed.

FIG. 8B schematically shows a cross section of the load sensor 1 along a plane parallel to a Y-Z plane at the center of a hole 31a, according to the present modification.

In the connection structure C1 in this case as well, the electrically-conductive elastic body 13 and the electric conductor 22 are electrically connected to each other. The connection structure C1 is composed of the thread 52, the first base member 11, the electrically-conductive part 12, the electrically-conductive elastic body 13, the hole 31a, the terminal part 24, and the second base member 21 that are within the range of the broken line shown in FIG. 8B.

However, in the present modification, since the terminal part 24 is provided to the lower face 21b of the second base member 21, the electrically-conductive elastic body 13 and the terminal part 24 cannot be pressed against each other. Therefore, in the present modification, the thread 52 that is electrically conductive is provided so as to extend across the first base member 11 and the second base member 21 at the position of the hole 31a. Accordingly, the electrically-conductive elastic body 13 and the terminal part 24 (the electric conductor 22) are electrically connected to each other.

### Effects of Modification of Embodiment 1

According to the present modification, the following effects are exhibited in addition to the effects similar to those in Embodiment 1.

The electric conductor 22 is formed on the face (the lower face 21b) on the side opposite to the opposing face 21a of the second base member 21. With this configuration, as compared with Embodiment 1 above, the electric conductor 22 is separated from the electrically-conductive member 41 by the thickness of the second base member 21. Accordingly, for example, as in the case of the element parts A12, A22, A32 in FIG. 7, even when the potentials of the electrically-conductive member 41 and the electric conductor 22 are different at the time of detection, parasitic capacitance occurring based on the potential difference between the electrically-conductive member 41 and the electric conductor 22 can be suppressed. Therefore, the capacitance in the element part A1 can be accurately detected.

As shown in FIG. 8B, in the connection structure C1, a member that is electrically conductive (the thread 52) is provided so as to extend across the first base member 11 and the second base member 21, whereby the electrically-conductive elastic body 13 and the electric conductor 22 are electrically connected to each other. With this configuration, also when the electric conductor 22 is on the lower face 21b of the second base member 21 as described above, the electrically-conductive elastic body 13 and the electric conductor 22 can be electrically connected to each other.

In the present modification, since the electric conductor 22 is formed on the lower face 21b of the second base member 21, a film or the like for protecting the load sensor 1 needs to be further disposed on the Z-axis negative side of the electric conductor 22. Meanwhile, in Embodiment 1 above, since the electric conductor 22 is formed on the upper face (the opposing face 21a) of the second base member 21, a film or the like for protection need not be disposed on the Z-axis negative side of the second base member 21. Therefore, from the viewpoint of configuring the load sensor 1 to be thin, Embodiment 1 above is more preferable.

### Embodiment 2

In Embodiment 1 above, the electric conductor 22 is continuously disposed along the conductor wire 40. However, in Embodiment 2, the electric conductor is disposed at the position of each of the element parts A1. In Embodiment 2 below, components having the same reference characters as those in Embodiment 1 are configured in the same manner as in Embodiment 1 unless otherwise specified.

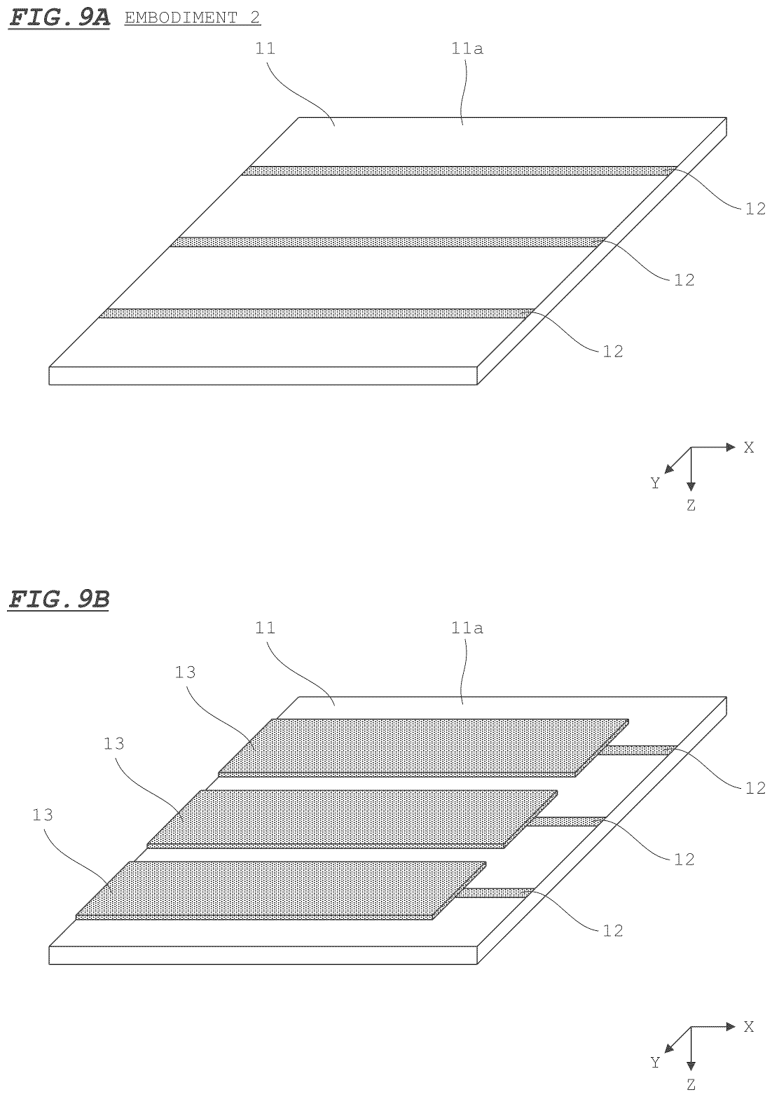

FIG. 9A is a perspective view schematically showing the first base member 11 and the electrically-conductive parts 12 formed on the opposing face 11a (the face on the Z-axis negative side) of the first base member 11, according to Embodiment 2. In Embodiment 2, an end portion on the X-axis positive side of the first base member 11 is extended in the X-axis positive direction. Accordingly, each electrically-conductive part 12 formed on the opposing face 11a of the first base member 11 is also extended in the x-axis positive direction.

FIG. 9B is a perspective view schematically showing a state where the electrically-conductive elastic bodies 13 are disposed on the structure in FIG. 9A. The size of each electrically-conductive elastic body 13 in Embodiment 2 is the same as that in Embodiment 1. Accordingly, on the X-axis positive side of the electrically-conductive elastic body 13, the electrically-conductive part 12 is open upward.

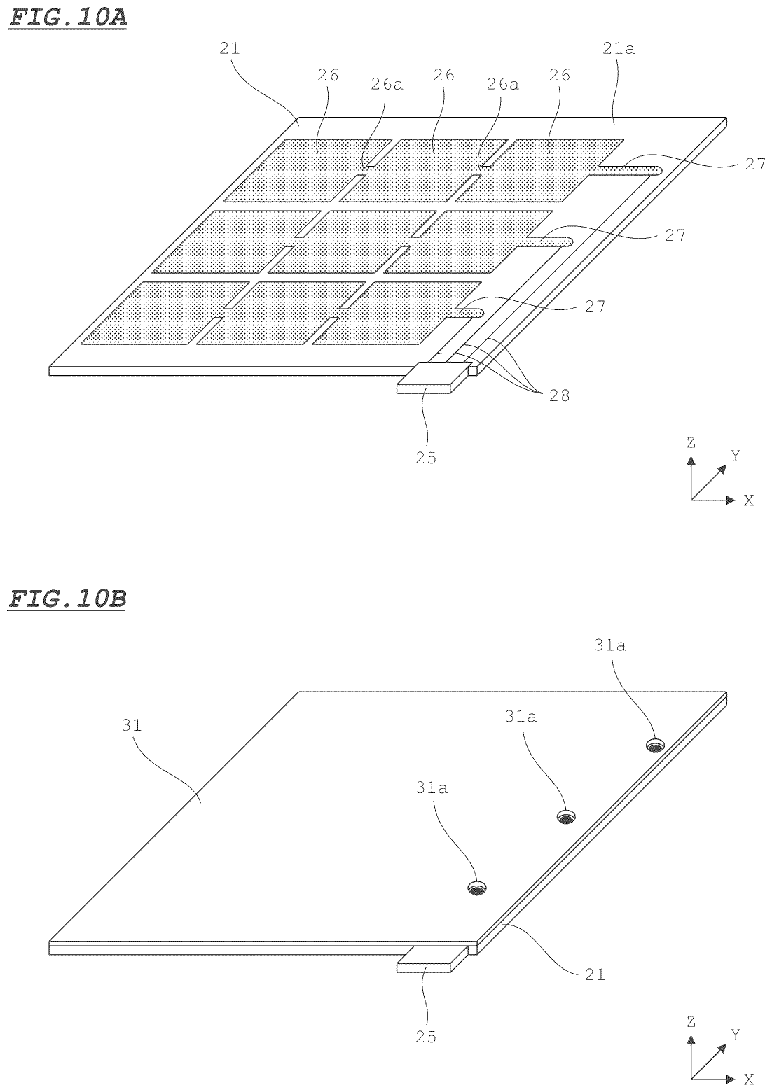

FIG. 10A is a perspective view schematically showing the second base member 21, and electric conductors 26, terminal parts 27, wires 28, and the connector 25 that are formed at the opposing face 21a (the face on the Z-axis positive side) of the second base member 21.

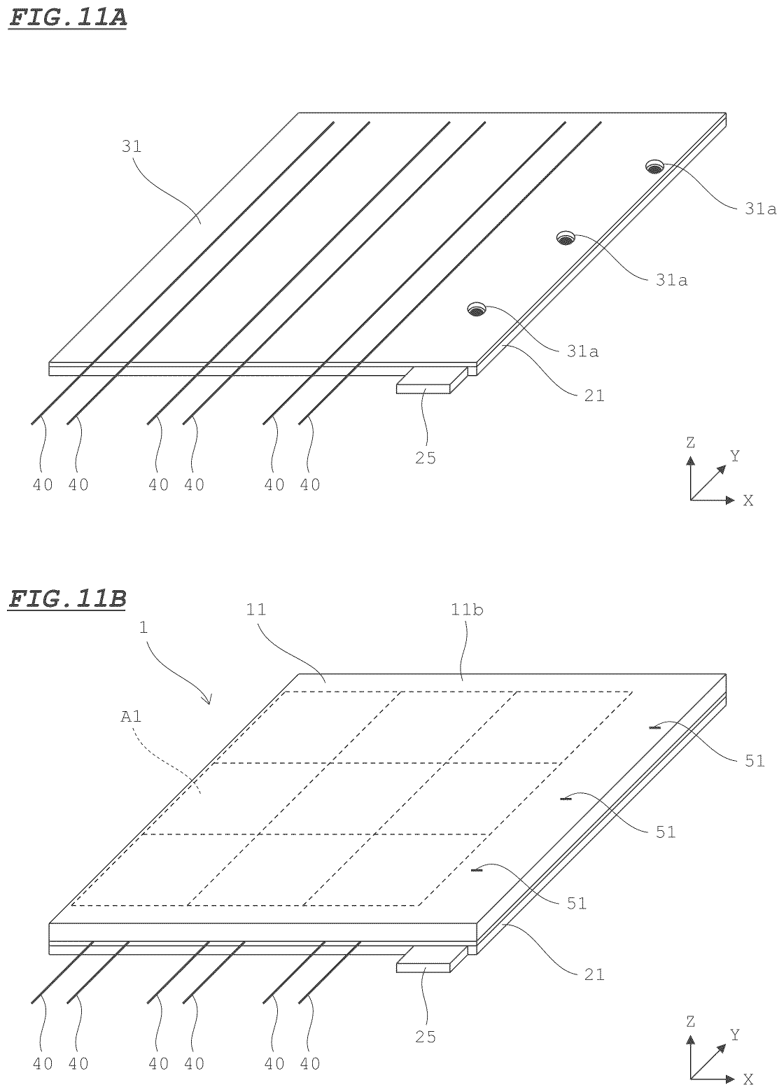

The electric conductors 26, the terminal parts 27, and the wires 28 are formed on the opposing face 21a of the second base member 21. In Embodiment 2 as well, similar to Embodiment 1, the element parts A1 (see FIG. 11B) are provided in a matrix shape. The electric conductor 26 is disposed at the position of each of the element parts A1 and has substantially the same size as that of the element part A1. Three electric conductors 26 arranged in the X-axis direction are connected to each other by connection parts 26a. Sets each composed of three electric conductors 26 arranged in the X-axis direction are arranged in the Y-axis direction with a predetermined gap therebetween. Each terminal part 27 extends in the X-axis positive direction from an end portion on the X-axis positive side of the corresponding electric conductor 26 disposed on the X-axis positive side. Each wire 28 extends from an end portion on the X-axis positive side of the corresponding terminal part 27, toward the side on the Y-axis negative side of the second base member 21.

Three electric conductors 26, two connection parts 26a, a terminal part 27 connected to these electric conductors 26, and a wire 28 connected to the terminal part 27 are integrally formed and in a state of being electrically connected to each other. The electric conductor 26, the connection part 26a, the terminal part 27, and the wire 28 are formed from the same material with each other, and similar to the electrically-conductive part 12 described above, are formed from a resin material and an electrically-conductive filler dispersed therein, or from a rubber material and an electrically-conductive filler dispersed therein. In Embodiment 2, the electrically-conductive filler forming the electric conductor 26, the connection part 26a, the terminal part 27, and the wire 28 is Ag (silver).

The electric conductor 26, the connection part 26a, the terminal part 27, and the wire 28 are formed on the opposing face 21a of the second base member 21 by a printing method such as screen printing, gravure printing, flexographic printing, offset printing, or gravure offset printing. With these printing methods, each component can be formed so as to have a thickness of about 0.001 mm to 0.5 mm on the opposing face 21a of the second base member 21. However, the method for forming each component is not limited to the above printing methods.

After the electric conductors 26, the connection parts 26a, the terminal parts 27, and the wires 28 have been formed on the second base member 21, the connector 25 is set at the side on the Y-axis negative side of the second base member 21 so as to be connected to the three wires 28. The connector 25 is a connector for connecting the wires 28 to an external circuit.

FIG. 10B is a perspective view schematically showing a state where the insulation film 31 is set on the structure in FIG. 10A.

The insulation film 31 has the same size as that of the second base member 21 in a plan view. In the insulation film 31, at a position corresponding to an end portion (an opposing part 27a described later) in the X-axis positive direction of each terminal part 27 in FIG. 10A, a hole 31a penetrating the insulation film 31 in the up-down direction is formed. The hole 31a is used for joining the electrically-conductive elastic body 13 and the terminal part 27 as described later.

FIG. 11A is a perspective view schematically showing a state where the conductor wires 40 are disposed on the structure in FIG. 10B. The conductor wires 40 are configured in the same manner as in Embodiment 1.

FIG. 11B is a perspective view schematically showing a state where the structure in FIG. 9B is set on the structure in FIG. 11A.

The structure in FIG. 9B is superposed upside down, from above (the Z-axis positive side) the structure in FIG. 11A. Accordingly, the conductor wires 40 come into contact with the electrically-conductive elastic bodies 13 disposed on the first base member 11.

Then, the threads 51 are sewn to the upper face 11b of the first base member 11 and the lower face 21b of the second base member 21 through the holes 31a. At this time, an electrically-conductive elastic body 13 is positioned above each hole 31a, and a terminal part 27 is positioned below the hole 31a. Therefore, as a result of the threads 51 being sewn to the upper face 11b and the lower face 21b, the electrically-conductive elastic bodies 13 and the terminal parts 27 are pressed against each other to be electrically connected.

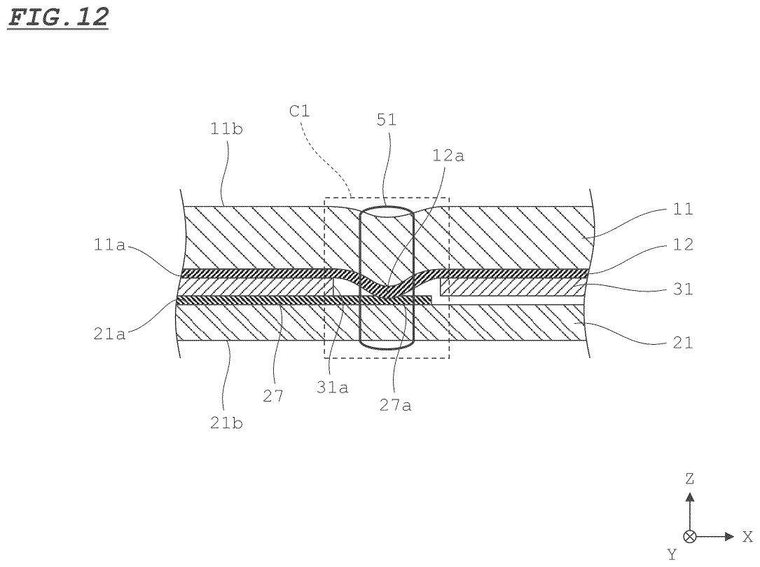

FIG. 12 schematically shows a cross section of the load sensor 1 along a plane parallel to an X-Z plane at the center of a hole 31a.

In Embodiment 2, the thread 51, the first base member 11, the electrically-conductive part 12, the hole 31a, the terminal part 27, and the second base member 21 that are within the range of the broken line shown in FIG. 12 form the connection structure C1 in which the electrically-conductive elastic body 13 and the electric conductor 26 are electrically connected to each other.

An opposing part 12a of the electrically-conductive part 12 connected to the electrically-conductive elastic body 13 is positioned above the hole 31a, and the opposing part 27a of the terminal part 27 is positioned below the hole 31a. That is, the opposing part 12a and the opposing part 27a oppose each other in the up-down direction (the Z-axis direction) through the hole 31a. As described above, when the thread 51 is sewn to the first base member 11 and the second base member 21 through the hole 31a, the opposing part 12a and the opposing part 27a are pressed against each other to be electrically connected.

With reference back to FIG. 11B, then, the outer periphery of the first base member 11 is connected to the second base member 21 by a thread, whereby the first base member 11 is fixed to the second base member 21. In this manner, the load sensor 1 is completed as shown in FIG. 11B. In Embodiment 2 as well, in a plan view, a plurality of the element parts A1 arranged in a matrix shape are formed as in Embodiment 1.

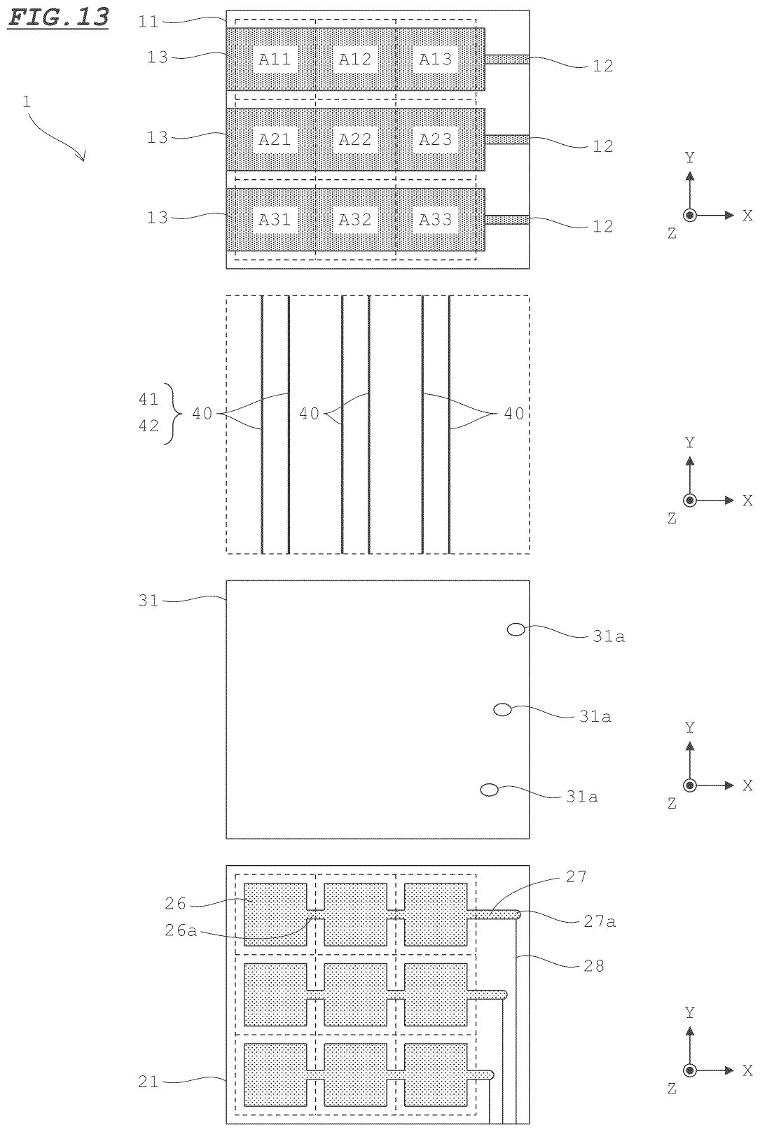

FIG. 13 is a plan view schematically showing disposition of components of the load sensor 1 when viewed in the Z-axis negative direction, according to Embodiment 2.

In FIG. 13, similar to FIG. 6, for convenience, a layer composed of the first base member 11 and the electrically-conductive elastic bodies 13, a layer composed of the conductor wires 40, a layer composed of the insulation film 31, and a layer composed of the second base member 21, the electric conductors 26, the terminal parts 27, and the wires 28 are arranged to be shown. The electrically-conductive elastic bodies 13 are shown in a state of being seen through the first base member 11.

The electrically-conductive elastic body 13 corresponding to the element parts A11 to A13 is connected to the terminal part 27 connected to the set of three electric conductors 26 on the Y-axis positive side, through the hole 31a on the X-axis positive side. Similarly, the electrically-conductive elastic body 13 corresponding to the element parts A21 to A23 is connected to the terminal part 27 connected to the set of three electric conductors 26 at the center, through the hole 31a at the center. The electrically-conductive elastic body 13 corresponding to the element parts A31 to A33 is connected to the terminal part 27 connected to the set of three electric conductors 26 on the Y-axis negative side, through the hole 31a on the X-axis negative side.

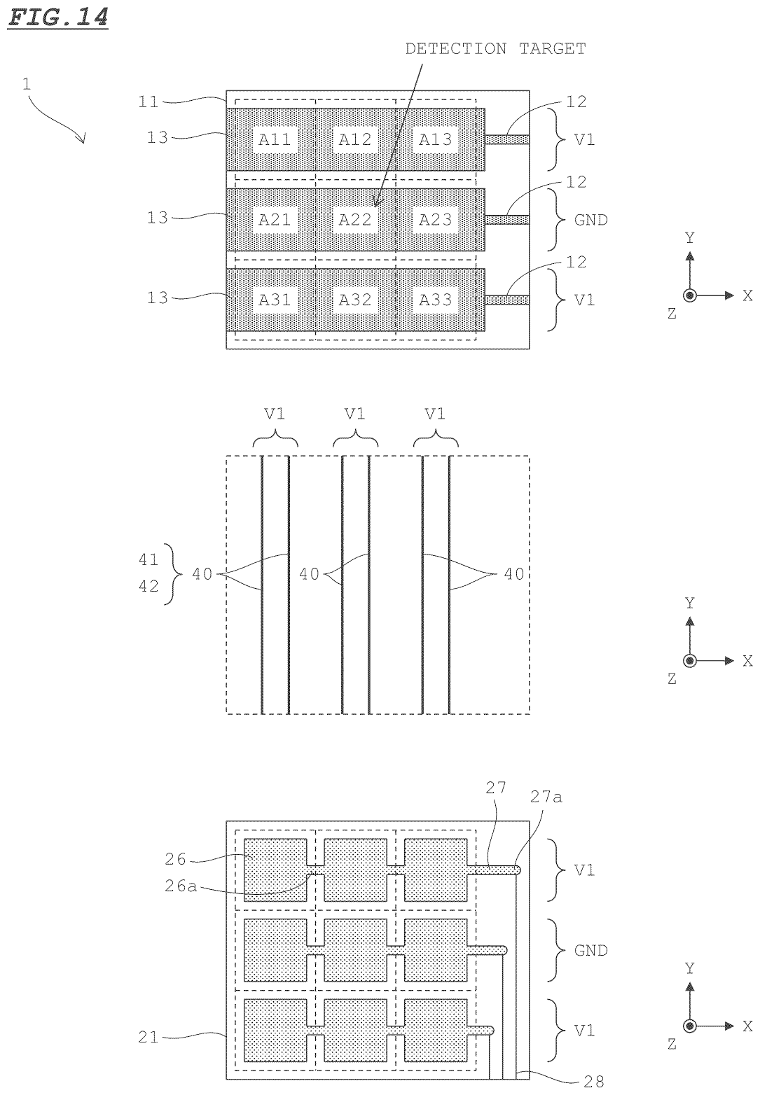

FIG. 14 is a schematic diagram showing the potential of each component when the element part A22 is the load detection target. Hereinafter, as an example, a procedure of detecting, when a load is applied to the element part A22 from the upper face 11b (see FIG. 11B) of the first base member 11, the load applied to the element part A22 will be described.

Similar to Embodiment 1 described with reference to FIG. 7, the external circuit connects the electrically-conductive elastic body 13 at the center corresponding to the element part A22 to the ground, and applies the constant voltage (Vcc) to the electrically-conductive members 41 in the pair of conductor wires 40 corresponding to the element part A22. Specifically, the external circuit connects the set of three electric conductors 26 at the center to the ground, thereby connecting the electrically-conductive elastic body 13 at the center to the ground. The external circuit applies the constant voltage (Vcc) to the electrically-conductive members 41 in the pair of conductor wires 40 at the center. Accordingly, the potential of the electrically-conductive elastic body 13 at the center becomes the ground potential (GND), and the potential V1 of the electrically-conductive members 41 in the pair of conductor wires 40 at the center gradually increases according to the time constant based on the capacitance in the element part A22.

Further, the external circuit sets the potentials of the electrically-conductive elastic bodies 13 and the electrically-conductive members 41 other than the element part A22 serving as the detection target, to the potential V1 which is the same as that of the pair of electrically-conductive members 41 at the center corresponding to the element part A22. Specifically, the external circuit sets the potential V1 to the set of three electric conductors 26 on the Y-axis positive side and the set of three electric conductors 26 on the Y-axis negative side, thereby setting the potential V1 to the electrically-conductive elastic bodies 13 on the Y-axis positive side and the Y-axis negative side. In addition, the external circuit sets the potential V1 to the electrically-conductive members 41 in the pairs of conductor wires 40 on the X-axis positive side and the X-axis negative side.

At a timing after elapse of a predetermined time from the application of the constant voltage (Vcc), the external circuit measures the potential V1 of the pair of electrically-conductive members 41 (the electrically-conductive members 41 corresponding to the element part A22 serving as the detection target) at the center. The external circuit calculates the capacitance in the element part A22, based on the measured potential V1. Then, the external circuit acquires the load applied to the element part A22, based on the calculated capacitance.

In Embodiment 2 as well, the layer composed of the electric conductors 26 is disposed on the Z-axis negative side (the lower side) of the layer composed of the conductor wires 40, and the potential V1 or the ground potential (GND) is set to the electric conductors 26. Accordingly, the lower side of the conductor wires 40 is electrically shielded by the electric conductors 26. In addition, the upper side of the conductor wires 40 is electrically shielded by the electrically-conductive elastic bodies 13, as in Embodiment 1. Therefore, even when a capacitance component comes close from the lower side and the upper side of the conductor wires 40, occurrence of an error in change in the potential V1 is suppressed. Accordingly, the capacitance detection accuracy is maintained at a high level.

### Effects of Embodiment 2

According to Embodiment 2, the following effects are exhibited in addition to the effects similar to those in Embodiment 1.

As shown in FIG. 13, at crossing positions between a plurality of the electrically-conductive elastic bodies 13 and a plurality of the electrically-conductive members 41, element parts A1 for detecting loads are formed respectively, and the electric conductor 26 is disposed at the position of each of the element parts A1. With this configuration, since the electric conductor 26 is formed so as to have substantially the same size as that of the region corresponding to the element part A1, an electrical shield can be effectively set for the region of the element part A1.

### Modification of Embodiment 2

In Embodiment 2 above, each electric conductor 26 is disposed on the upper face (the opposing face 11a) of the second base member 21. However, the electric conductor 26 may be disposed on the lower face 21b of the second base member 21.

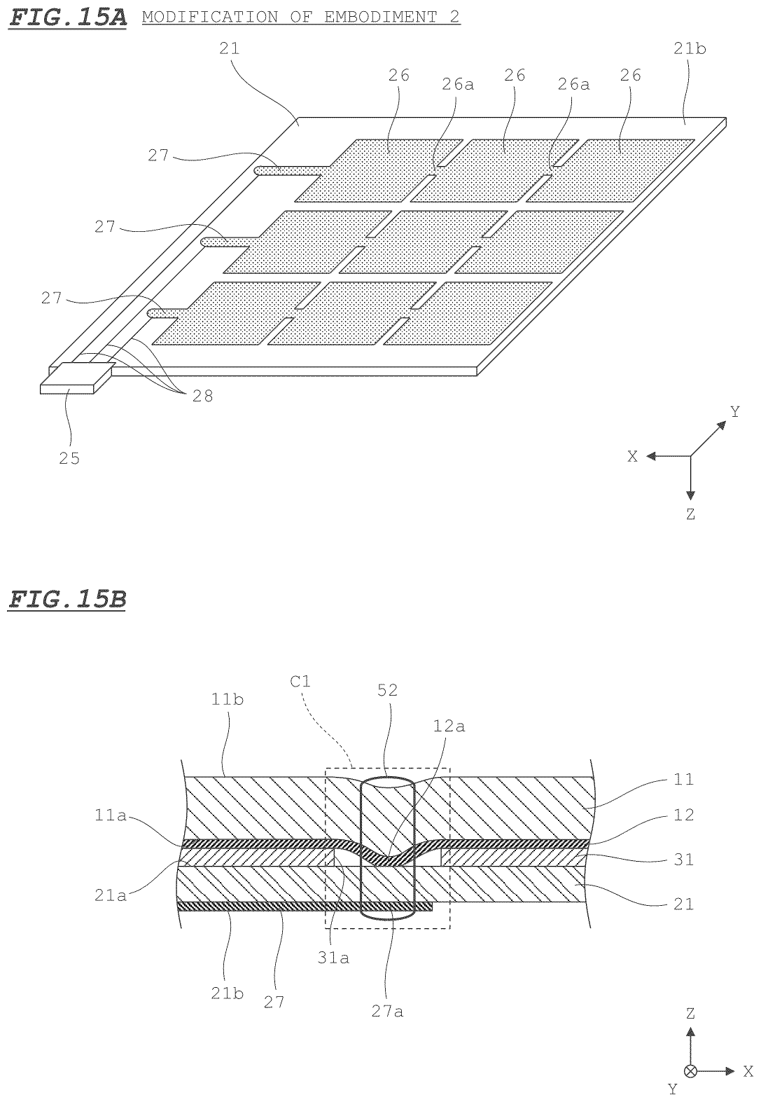

FIG. 15A is a perspective view schematically showing the second base member 21, and the electric conductors 26, the terminal parts 27, the wires 28, and the connector 25 that are formed at the lower face 21b (the face on the Z-axis negative side) of the second base member 21, according to the present modification.

The disposition of the electric conductors 26, the connection parts 26a, the terminal parts 27, the wires 28, and the connector 25 of the present modification when viewed in the Z-axis negative direction is the same as that of Embodiment 2 above. The present modification is configured in the same manner as Embodiment 2 above except that each component set to the second base member 21 is disposed at the lower face 21b of the second base member 21. The insulation film 31 and the conductor wires 40 in FIG. 11A are disposed from above (the Z-axis positive side) the structure in FIG. 15A inverted upside down, the structure in FIG. 9B is superposed upside down thereon, and the threads 52 are sewn. In this manner, the load sensor 1 is completed.

FIG. 15B schematically shows a cross section of the load sensor 1 along a plane parallel to an X-Z plane at the center of a hole 31a, according to the present modification.

In the connection structure C1 in this case as well, the electrically-conductive elastic body 13 and the electric conductor 26 are electrically connected to each other. The connection structure C1 is composed of the thread 52, the first base member 11, the electrically-conductive part 12, the hole 31a, the terminal part 27, and the second base member 21 that are within the range of the broken line shown in FIG. 15B.

However, in the present modification, since the terminal part 27 is provided to the lower face 21b of the second base member 21, the electrically-conductive elastic body 13 and the terminal part 27 cannot be pressed against each other. Therefore, in the present modification, the thread 52 that is electrically conductive is provided so as to extend across the first base member 11 and the second base member 21 at the position of the hole 31a. Accordingly, the electrically-conductive elastic body 13 and the terminal part 27 (the electric conductor 26) are electrically connected to each other.

### Effects of modification of Embodiment 2

According to the present modification, the following effects are exhibited in addition to the effects similar to those in Embodiment 2.

The electric conductor 26 is formed on the face (the lower face 21b) on the side opposite to the opposing face 21a of the second base member 21. With this configuration, as compared with Embodiment 2 above, the electric conductor 26 is separated from the electrically-conductive member 41 by the thickness of the second base member 21. Accordingly, for example, as in the case of the element parts A21, A22, A23 in FIG. 14, even when the potentials of the electrically-conductive member 41 and the electric conductor 26 are different at the time of detection, parasitic capacitance occurring based on the potential difference between the electrically-conductive member 41 and the electric conductor 26 can be suppressed. Therefore, the capacitance in the element part A1 can be accurately detected.

As shown in FIG. 15B, in the connection structure C1, a member that is electrically conductive (the thread 52) is provided so as to extend across the first base member 11 and the second base member 21, whereby the electrically-conductive elastic body 13 and the electric conductor 26 are electrically connected to each other. With this configuration, also when the electric conductor 26 is on the lower face 21b of the second base member 21 as described above, the electrically-conductive elastic body 13 and the electric conductor 26 can be electrically connected to each other.

In the present modification, a film or the like for protecting the load sensor 1 needs to be further disposed on the Z-axis negative side of the electric conductor 26. Meanwhile, in Embodiment 2 above, a film or the like for protection need not be disposed on the Z-axis negative side of the second base member 21. Therefore, from the viewpoint of configuring the load sensor 1 to be thin, Embodiment 2 above is more preferable.

### Other Modifications

In Embodiment 1 above, the terminal part 24 (see FIG. 4) joined to the electrically-conductive elastic body 13 by the thread 51 may have projections and recesses on the opposing part 24a (the face on the Z-axis positive side). When there are projections and recesses on the opposing part 24a like this, as compared with a case where the surface is a flat surface, the contact area between the opposing part 24a and the opposing part 13a of the electrically-conductive elastic body 13 becomes large. Therefore, the resistance value in the connection portion between the opposing part 24a and the opposing part 13acan be kept low.

Similarly, in Embodiment 2 above, the terminal part 27 (see FIG. 12) joined to the electrically-conductive part 12 by the thread 51 may have projections and recesses on the opposing part 27a (the face on the Z-axis positive side). When there are projections and recesses on the opposing part 27a like this, as compared with a case where the surface is a flat surface, the contact area between the opposing part 27a and the opposing part 12a of the electrically-conductive part 12 becomes large. Therefore, the resistance value in the connection portion between the opposing part 27a and the opposing part 12a can be kept low. The electrically-conductive part 12 may have projections and recesses on the opposing part 12a.

In the modification of Embodiment 1 above, as shown in FIG. 8B, the electrically-conductive elastic body 13 and the terminal part 24 are electrically connected by the thread 52 that is electrically conductive, and in the modification of Embodiment 2 above, as shown in FIG. 15B, the electrically-conductive part 12 and the terminal part 27 are electrically connected by the thread 52 that is electrically conductive. However, not limited thereto, instead of the thread 52, an electrically-conductive tubular member (eyelet) having a hole penetrating in the up-down direction, or an electrically-conductive screw may electrically connect the above two members serving as the connection target.

In Embodiments 1 and 2 above, the non-electrically-conductive thread 51 is used, but the electrically-conductive thread 52 may be used. In this case, instead of the electrically-conductive thread 52, an electrically-conductive tubular member (eyelet) or an electrically-conductive screw may be used.

In the modifications of Embodiments 1 and 2 above, the electrically-conductive thread 52 is used, but the thread 51 that is non-electrically-conductive may be used. In the case of the modification of Embodiment 1 above, for example, a hole may be provided in the second base member 21 at the position of the opposing part 24a (see FIG. 8B) of the terminal part 24, and through this hole, the electrically-conductive elastic body 13 and the terminal part 24 may be pressed against each other. In the case of the modification of Embodiment 2 above, for example, a hole may be provided in the second base member 21 at the position of the opposing part 27a (see FIG. 15B) of the terminal part 27, and through this hole, the electrically-conductive part 12 and the terminal part 27 may be pressed against each other.

In Embodiments 1 and 2 above and the modifications of these, the insulation film 31 need not necessarily be provided over the entire region as shown in FIGS. 6, 13. However, in Embodiment 2 above, in order to allow the electrically-conductive part 12 of the first base member 11 and the terminal part 27 and the wire 28 of the second base member 21 to be insulated from each other, the insulation film 31 needs to be provided in this region. Although the electrically-conductive member 41 and the electric conductor 22, 26 are not electrically connected to each other due to the dielectric body 42, in a case where the electric conductor 22, 26 is disposed on the opposing face 21a of the second base member 21 as shown in Embodiment 1, 2, it is preferable that the insulation film 31 is provided over the entire region.

In Embodiments 1 and 2 above and the modifications of these, the second base member 21 and the insulation film 31 may be formed from a rubber material having an insulation property. However, as described above, when the second base member 21 and the insulation film 31 are formed from a resin material, the cost can be more reduced.

In Embodiments 1 and 2 above and the modifications of these, the electric conductor is disposed only on either one of the upper face and the lower face of the second base member 21. However, the electric conductor may be disposed on both of the upper face and the lower face. For example, in Embodiment 2 and the modification thereof, as shown in FIG. 13, the electric conductors 26 are arranged with a gap therebetween in the Y-axis direction. Therefore, so as to fill these gaps, other electric conductors may be further disposed along the conductor wires 40 on the face opposite to the face, of the second base member 21, on which the electric conductors 26 are disposed.

In Embodiments 1 and 2 above and the modifications of these, the electrically-conductive elastic body 13 and the electric conductor formed on the second base member 21 need not necessarily be electrically connected to each other. In this case, wires are individually drawn from the electrically-conductive elastic body 13 and the electric conductor so that voltages can be separately applied to the electrically-conductive elastic body 13 and the electric conductor formed on the second base member 21. However, from the viewpoint of simplification of the configuration, as described above, it is preferable that the electrically-conductive elastic body 13 and the electric conductor are electrically connected to each other.

In the modifications of Embodiments 1 and 2 above, the thread 52 is a member that is electrically conductive, and the first base member 11 and the second base member 21 are sewn to each other through the holes 31a in the insulation film 31. However, in these modifications, since the thread 52 is formed from a material that is electrically conductive, the holes 31a need not necessarily be provided in the insulation film 31.

In Embodiments 1 and 2 above and the modifications of these, as shown in FIG. 1B and FIG. 9B, the load sensor 1 includes three sets each composed of an electrically-conductive elastic body 13 and an electrically-conductive part 12. However, the load sensor 1 may include at least one set composed of an electrically-conductive elastic body 13 and an electrically-conductive part 12. For example, the number of the above sets included in the load sensor 1 may be one. In this case, the pair of conductor wires 40 and the electric conductor 22, 26 are changed in accordance with the layout of the element part A1.

In Embodiments 1 and 2 above and the modifications of these, as shown in FIG. 3A and FIG. 11A, the load sensor 1 includes three pairs of conductor wires 40. However, the load sensor 1 may include at least one pair of conductor wires 40. For example, the number of the pairs of conductor wires 40 included in the load sensor 1 may be one. In this case, the electrically-conductive elastic body 13, the electrically-conductive part 12, and the electric conductor 22, 26 are changed in accordance with the layout of the element part A1.

In Embodiments 1 and 2 above and the modifications of these, two conductor wires 40 arranged in the X-axis direction are included in the element part A1, but one, three, or more conductor wires 40 may be included.

In Embodiments 1 and 2 above and the modifications of these, as shown in FIGS. 5A, 5B, each conductor wire 40 is composed of one electrically-conductive member 41 and the dielectric body 42 covering this electrically-conductive member 41. However, not limited thereto, the conductor wire 40 may be implemented by a twisted wire in which a plurality of the conductor wires as above are bundled. The conductor wire 40 may be composed of a twisted wire in which a plurality of the electrically-conductive members are bundled and a dielectric body covering this twisted wire. In these cases, flexibility of the conductor wire 40 can be enhanced, and the strength against bending of the conductor wire 40 can be enhanced.

In addition to the above, various modifications can be made as appropriate to the embodiments of the present invention without departing from the scope of the technical idea defined by the claims.

What is claimed is:

1. A load sensor comprising:
a first base member having a plate shape and having elasticity;
a second base member having a plate shape and disposed so as to oppose the first base member;
an electrically-conductive elastic body formed on an opposing face of the first base member;
an electrically-conductive member having a linear shape and disposed between the first base member and the second base member;
a dielectric body formed on an outer periphery of the electrically-conductive member; and
an electric conductor formed on the second base member, along the electrically-conductive member.

2. The load sensor according to claim 1, wherein
the electric conductor is formed on an opposing face of the second base member.

3. The load sensor according to claim 2, comprising
an insulation film disposed between the second base member and the electrically-conductive member.

4. The load sensor according to claim 1, wherein
the electric conductor is formed on a face on a side opposite to an opposing face of the second base member.

5. The load sensor according to claim 1, further comprising
a connection structure in which the electrically-conductive elastic body and the electric conductor are electrically connected to each other.

6. The load sensor according to claim 5, wherein
an elastic modulus of the second base member is higher than an elastic modulus of the first base member.

7. The load sensor according to claim 5, wherein
an elastic modulus of the second base member is 30 MPa or more.

8. The load sensor according to claim 5, wherein
in the connection structure, opposing parts disposed, so as to oppose each other, at respective opposing faces of the first base member and the second base member are pressed against each other, whereby the electrically-conductive elastic body and the electric conductor are electrically connected to each other.

9. The load sensor according to claim 8, wherein
in the connection structure, the first base member and the second base member are sewn to each other at a position of the two opposing parts, thereby causing these opposing parts to be pressed against each other.

10. The load sensor according to claim 5, wherein
in the connection structure, a member that is electrically conductive is provided so as to extend across the first base member and the second base member, whereby the electrically-conductive elastic body and the electric conductor are electrically connected to each other.

11. The load sensor according to claim 1, wherein
a plurality of the electrically-conductive elastic bodies extending in one direction are formed on the first base member so as to be arranged in a width direction,
a plurality of the electrically-conductive members are disposed so as to be arranged in such a manner as to cross the plurality of the electrically-conductive elastic bodies, and
the electric conductor is continuously disposed along each of the electrically-conductive members.

12. The load sensor according to claim 1, wherein
a plurality of the electrically-conductive elastic bodies extending in one direction are formed on the first base member so as to be arranged in a width direction,
a plurality of the electrically-conductive members are disposed so as to be arranged in such a manner as to cross the plurality of the electrically-conductive elastic bodies,
an element part for detecting a load is formed at each of crossing positions between the plurality of the electrically-conductive elastic bodies and the plurality of the electrically-conductive members, and
the electric conductor is disposed at a position of each of the element parts.
